(19) United States
(12) Patent Application Publication
(10) Pub. No.: US 2026/0036259 A1
(43) Pub. Date: Feb. 5, 2026

(54) Air Pressure Vessel For A Transportation Vehicle

(71) Applicant: WAL Fuel Systems USA Inc., Livonia, MI (US)

(72) Inventors: Xiankai Song, Livonia, MI (US); Sami Siddiqui, Livonia, MI (US); Longhan Chen, Livonia, MI (US); Zhaoqi Zhang, Livonia, MI (US)

(21) Appl. No.: 19/351,944

(22) Filed: Oct. 7, 2025

Related U.S. Application Data
(63) Continuation-in-part of application No. 18/352,582, filed on Jul. 14, 2023, now Pat. No. 12,449,093.

(51) Int. Cl. F17C 1/08; B60K 15/03; B60T 17/06

(52) U.S. Cl. CPC F17C 1/08; B60K 15/03006; B60K 15/03177; B60K 2015/03493; B60T 17/06; F17C 2201/0109; F17C 2201/0166; F17C 2203/012; F17C 2203/066; F17C 2205/0103; F17C 2205/0311; F17C 2221/031; F17C 2270/0168

(57) ABSTRACT

A pressure vessel for vehicle for containing and selectively providing pressurized air. The pressure vessel includes a first end cap and a second end cap connected to the first end cap to define an inner volume. In one example, a central shell is positioned between and connected to the first end cap and the second end cap. The first end cap and the second end cap each include reinforcement ribs and a mount positioned on each end of the pressure vessel to mount the pressure vessel to a vehicle. In one example an insert is used to reinforce the air ports or a drain port in communication with an inner volume of the pressure vessel. A mold cavity die for forming an injection molded pressure vessel and a method for inserting a reinforcement in an injection molded pressure vessel is disclosed.

### CROSS-REFERENCE TO RELATED APPLICATION(S)

The present continuation-in-part application claims priority benefit to U.S. patent application Ser. No. 18/352,582 filed Jul. 14, 2023, the entire contents of which are incorporated herein by reference in the entirety for all purposes.

### TECHNICAL FIELD

The present disclosure relates generally to the field of vessels or containers that store and selectively release pressurized gasses. Non-exclusive applications include use in transportation vehicles or passenger vehicles.

### BACKGROUND

Pressure vessels for use in storing pressurized gasses, for example pressurized air, are useful to store pressurized air onboard the vehicle and selectively provide the pressurized air to assist or support other vehicle systems. Prior air pressure vessels used in transportation vehicles have been formed of metallic materials which add significant weight to vehicles, are limited in design features and fabrication, and are costly to manufacture. Prior air pressure vessels used in transportation vehicles that were not made from metallic materials include disadvantages in the mounting schemes and structures for mounting the pressure vessels in the vehicles, and other disadvantages in the design, manufacturing and durability of the pressure vessels.

### SUMMARY

In one example of the present invention, a pressure vessel is disclosed. In one example of the pressure vessel includes a first end cap including a first end and a distal end spaced in the axial direction. The first end cap includes a wall formed from polymeric material extending between the first end and the distal end of the first end cap. The first end cap includes a first mount positioned at the first end of the first end cap configured to mount the vessel to an object. The pressure vessel includes a second end cap spaced in the axial direction from the first end cap. The second end cap includes a first end and a distal end spaced in the axial direction. The distal end of the second end cap is connected to the distal end of the first end cap at a central seam. The second end cap includes a wall formed from polymeric material extending between the first end and the distal end and a second mount positioned at the first end of the second end cap configured to mount the pressure vessel to the object. The wall of the first end cap and the second end cap each includes an inner surface and an outer surface. The inner surface of the first end cap and the second end cap forming an inner volume of the pressure vessel. The pressure vessel includes an external sheath substantially surrounding the outer surface of the first end cap and the second end cap.

In one example of the pressure vessel, the first mount includes a mount insert engaged with the wall of the first end cap and a fastener engaged with the mount insert of the first end cap. The first mount includes a first mounting bracket connected to the mount insert of the first end cap by the fastener. The pressure vessel includes a second mount including a mount insert engaged with the wall of the second end cap and a fastener engaged with the mount insert of the second end cap. The second mount includes a second mounting bracket connected to the mount insert of the second end cap by the fastener.

In another example of the pressure vessel, the first end cap and the second end cap each include reinforcing ribs integrally formed in the wall at the first ends, respectively. The mount insert for the first mount and the mount insert for the second mount are integrally molded into the reinforcing ribs in the first end cap and the second end cap, respectively.

In another example of the present invention, an air pressure vessel for use in a transportation vehicle is disclosed. The air pressure vessel includes a first end cap having a first end and a distal end spaced in the axial direction. The first end cap includes a wall formed from polymeric material extending between the first end and the distal end and reinforcing ribs integrally formed in the wall at the first end. The first end cap includes a first mount positioned at the first end of the first end cap and connected to the reinforcing ribs of the first end cap. The first mount configured to mount the air pressure vessel to a transportation vehicle. The air pressure vessel includes a second end cap spaced in the axial direction from the first end cap and having a first end and a distal end spaced in the axial direction. The distal end of the second end cap is connected to the distal end of the first end cap at a central seam. The second end cap includes a wall formed from polymeric material extending between the first end and the distal end and reinforcing ribs integrally formed in the wall at the first end of the second end cap. The second end cap includes a second mount positioned at the first end and connected to the reinforcing ribs of the second end cap. The second mount is configured to mount the air pressure vessel to the transportation vehicle. The wall of the first end cap and the second end cap each includes an inner surface and an outer surface. The inner surface of the first end cap and the second end cap defining an inner volume of the pressure vessel. The air pressure vessel further includes an external sheath substantially surrounding the outer surface of the first end cap and the second end cap.

In one aspect of the invention, an alternate pressure vessel is disclosed. The pressure vessel includes a first end cap having a first end and a distal end spaced along the longitudinal axis. The pressure vessel includes a second end cap having a first end and a distal end spaced along the longitudinal axis, the distal end of the second end cap is connected to the distal end of the first end cap at a central seam. The first end cap and the second end cap include a wall formed from a polymeric material and define an inner volume of the pressure vessel. The pressure vessel includes an insert engaged with the wall and defining an opening having an axis in communication with the inner volume.

In one aspect of the invention, the invention includes a mold cavity die for an injection molded part. The mold cavity die includes a frame movable along a slide axis between a first position and a second position and a cavity die connected to and movable with the frame. The cavity die includes an inner surface configured to form an exterior surface of the injection molded part. The cavity die includes an insert die extending inward and parallel to an insert die axis toward a longitudinal axis of the injection molded part. The insert die includes a base having a distal end including an insert surface and a retainer connected to the base configured to removably secure a reinforcement in a predetermined position relative to the insert die. Wherein in the second position of the frame, the reinforcement is positioned in a mold cavity and substantially surrounded on injection of a molten material into the mold cavity.

In one aspect of the invention, the invention includes a method for inserting a reinforcement in an injection molded part. The method includes providing a mold core die, providing a mold cavity die configured to receive the mold core die and forming a mold cavity defining the injection molded part. The mold cavity die having an insert die configured to position the reinforcement in a predetermined position in the mold cavity. The method includes engaging the reinforcement with the insert die to position the reinforcement in a predetermined position relative to the insert die. Moving the mold cavity die relative to the mold core die to form the mold cavity and positioning the reinforcement in the predetermined position in the mold cavity, and injecting molten material into the mold cavity to form the injection molded part, wherein the molten material substantially surrounds the reinforcement.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1A is frontal perspective view of one example of a pressure vessel.

FIG. 1B is a right side perspective view of the pressure vessel of FIG. 1.

FIG. 2A is an upper frontal perspective view of an alternate pressure vessel shown as a first end cap.

FIG. 2B is lower rear perspective view of the alternate pressure vessel in FIG. 2A shown as a second end cap.

FIG. 3 is a partial cross-sectional view taken along line 3-3 in FIG. 1B.

FIG. 4 is a bottom view of one example of a first end cap and/or a second end cap.

FIG. 5 is an upper perspective view of one example of outer ribs in the first end cap and/or the second end cap.

FIG. 6 is a lower rear perspective and partial cross-sectional view of one example of the inner ribs of FIG. 4.

FIG. 7 is an enlarged, schematic cross-sectional view taken along line 7-7 in FIG. 1B of one example of a first mount and/or a second mount of the pressure vessel.

FIG. 8 is an upper right perspective view of an alternate example of a first mount and/or a second mount of the pressure vessel.

FIG. 9 is a partial cross sectional view taken along line 9-9 in FIG. 1B showing one example of an insert.

FIG. 10A is an upper left perspective view of an alternate insert.

FIG. 10B is a lower left perspective view of the insert in FIG. 10A.

FIG. 10C is a left frontal perspective and cross-sectional view taken along lines 10C-10C in FIG. 10A.

FIG. 10D is cross-sectional view taken along line 10D-10D of the insert of FIG. 10A shown molded into an annular flange of the pressure vessel.

FIG. 11A is frontal perspective view of an alternate insert.

FIG. 11B is a cross-sectional view taken along line 11B-11B of the insert of FIG. 11A shown installed in an annular flange of the pressure vessel.

FIG. 12A is a rotated left side perspective view of an example of a mold cavity die. vessel.

FIG. 12B is a rotated rear right side perspective view of the mold die cavity of FIG. 12A.

FIG. 12C is a front right side perspective view of the mold cavity die of FIG. 12A.

FIG. 12D is an upper right side perspective view of the mold die cavity of FIG. 12C shown engaged with a second cavity die.

FIG. 13 is an upper rear side perspective view of the mold die cavity of FIG. 12C shown with a third cavity die, a fourth cavity die, and a fifth cavity die.

FIG. 14 is an enlarged perspective view of the area A in FIG. 12A.

FIG. 15 is a schematic partial cross-sectional view taken along line 15-15 in FIG. 14.

FIG. 16 is a schematic flow chart of one example of a method for inserting a reinforcement in an injection molded part.

FIG. 17 is an upper perspective, exploded view of an alternate example of a pressure vessel.

### DETAILED DESCRIPTION

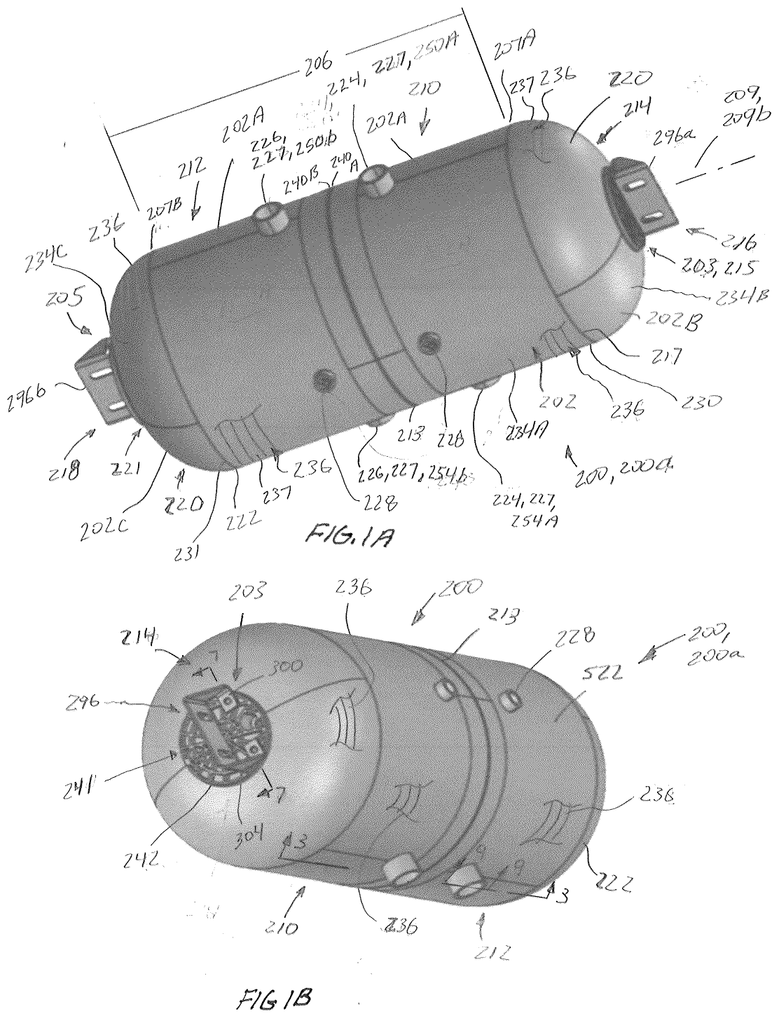

The disclosure herein, and as more particularly described in FIGS. 1A-11B below, relates to a pressure vessel for containing and selectively providing or supplying pressurized gas (e.g., pressurized air) or other fluids for use downstream of the pressure vessel. In one example described below, the disclosure includes an example of an air pressure vessel for use in a object, for example a vehicle, or a transportation vehicle. In one example application, the pressure vessel is useful to store and selectively provide or supply pressurized air to other vehicle systems in a transportation vehicle. In one example, the vehicle or the transportation vehicle is a passenger vehicle (e.g., car, truck, mass transit vehicles) and other similar transportation vehicles as known by persons skilled in the art. In one example application, the pressure vessel is a used as a brake tank air pressure vessel configured to store and selectively provide pressurized air for use by the vehicle brake system.

Referring to the example pressure vessel shown in FIG. 17, in selected embodiments, a pressure vessel 100 may be configured to store one or more fluids. The pressure vessel 100 may be used in various applications. For example, the pressure vessel 100 may be used as part of a vehicle system. Specifically, the pressure vessel 100 may be to hold fuel (e.g., gases or liquids) at elevated pressures (e.g., pressures that exceed atmospheric pressure). The pressure vessel 100 may help store fuel that may be used by an engine and may dispense the fuel at a flow rate needed by the engine, which then may burn the fuel to generate energy to propel the vehicle.

In certain embodiments, the pressure vessel 100 may be formed of polymeric material having various reinforcements as desired or necessary. Polymeric material may offer several benefits due to its being lightweight and easily formable. The lightweight property of polymeric material may contribute to reducing the weight of a vehicle that incorporates or used the pressure vessel 100. This reduction in weight may enhance the overall fuel efficiency of the vehicle by reducing operational costs, pollutant emissions, etc. At the same time, with the application of various reinforcements, a pressure vessel 100 formed of polymeric material may also be capable of resolving stresses associated with elevated pressure within the pressure vessel 100 and preventing leaks, ensuring the safe and reliable use of the pressure vessel 100, and the like.

In selected embodiments of the example in FIG. 17, the pressure vessel 100 may comprise a wall 102 defining the shape and total volume of the pressure vessel 100. The shape may be cylindrical or tubular. The wall 102 may include of a barrier 104 and a support portion 106 providing structural support to the barrier 104.

In selected embodiments, the barrier 104 may be formed of a polymeric material. The support portion 106 may also be formed of a polymeric material. The polymeric material of the support portion 106 may be the same as or different from the polymeric material forming the barrier 104. The barrier 104 and the support portion 106 may be monolithic, which refers to a single piece of material without joints or seams. As a result, it may provide increased resistance to leaks and elevated pressures.

Still referring to FIG. 17, in certain embodiments, the support portion 106 may be or comprise external ribs 108 arranged on an outer surface of the barrier 104. The external ribs 108 may be reinforcing ribs reinforcing and providing support to the barrier 104. A thickness of the external ribs 108 may range from about 1 mm to about 3 mm. In another example, the thickness of the external ribs 108 may range from about 2 mm to about 3 mm. In another example, the thickness of the external ribs 108 may range from about 2.2 mm to about 2.7 mm. The external ribs 108 may be arranged in any suitable pattern.

As the local stresses imposed on the different portions of the pressure vessel 100 may be different, the pattern of the external ribs 108 may vary across those different portions in order to properly support the barrier 104. For example, the pattern, spacing between the external ribs 108, thickness and depth of the external ribs 108, or the like may be selected to provide a desired strength to the support portion 106. In selected embodiments, the external ribs 108 or a subset thereof may form a radial pattern (e.g., external ribs 108 that extend radially away from a sub-component such as an aperture or port in the pressure vessel 100). Alternatively or in addition thereto, the external ribs 108 may intersect so as to formed a particular shape (e.g., a repeating shape) therebetween. For example, the external ribs 108 or a subset thereof may intersect to form a diamond pattern, a honeycomb pattern, a square pattern, a rectangular pattern, a triangular pattern, and the like, or a combination or sub-combination thereof. Stated differently, the external ribs 108 may be arranged to form a pattern comprising at least one of a radial pattern, a diamond pattern, a honeycomb pattern, a square pattern, a rectangular patter, and a triangular pattern.

In certain embodiments, the pattern may be or comprise external ribs 108 that extend circumferentially (i.e., in a circumferential direction 109a) around the pressure vessel 100, external ribs 108 that extend axially (i.e., in an axial direction 109b) with respect to the pressure vessel 100, or the like, or a combination or sub-combination thereof. Intersections between such ribs may be orthogonal, or at some other angle. For example, as the external ribs 108 that extend axially approach an end of the pressure vessel 100, they may converge or the like and cross the external ribs 108 that extend circumferentially at an angle that is less than or more than ninety degrees.

From a technological standpoint, it may be easier to form the external ribs 108 in certain locations on the pressure vessel 100 in different patterns than on other locations. Accordingly, the patterns for particular areas may be selected to provide a desired support strength, manufacturability, economy of material (e.g., efficient or optimal use of the material used to form the pressure vessel 100), or the like. In selected embodiments, the external ribs 108 forming in a radial pattern may be used around one or more apertures or ports in the pressure vessel 100, while the external ribs 108 forming a diamond pattern, a honeycomb pattern, a square pattern, rectangular pattern, or the like, may be effective over large portions or the majority of the pressure vessel 100. In certain embodiments, to resolve or carry hoop stress, certain portions of a pressure vessel 100 may include a higher density of external ribs 108 that extend circumferentially around the pressure vessel 100. That is, the external ribs 108 that extend circumferential may be closer together (e.g., have a reduced spacing in the axial direction 109b therebetween) so as to increase a load carrying capacity of selected regions or portion of the pressure vessel 100.

Still referring to FIG. 17, in selected embodiments, the pressure vessel 100 may include a body 101. The body 101 may extend between a first end 103 and a second end 105. The body 101 may include an upper shell 110 (i.e., a first portion) and a lower shell 112 (i.e., a second portion). The upper shell 110 and the lower shell 112 may be substantially similar in structure to one another to promote ease of manufacturing and reduce production costs. The upper shell 110 may contain a first section of the barrier 104, and the lower shell 112 may contain a second section of the barrier 104. Similarly, the upper shell 110 may contain a first section of the support portion 106, and the lower shell 112 may contain a second section of the support portion 106. In other words, the upper shell 110 may contain a first segment of the wall 102, and the lower shell 112 may contain a second segment of the wall 102. One end of the upper shell 110 may be connected securely to one end of the lower shell 112 by welding (e.g., friction or ultrasonic welding) or the like. When welding, the selected areas or surfaces of the upper shell 110 and the lower shell 112 may abut to form a welded seam 114 when the material melt and fuse together during a welding process such that the upper shell 110 (i.e., the first portion) and the lower shell 112 (i.e., the second portion) are substantially symmetric about the welded seam 114, as seen in FIGS. 1-3, for example. The selected areas may include annular areas in the first segment of the wall 102 and the second segment of the wall 102.

In the FIG. 17 example, in certain embodiments, the upper shell 110 may include one or more first mounts 116 and the lower shell 112 may include one or more second mounts 118. The one or more first mounts 116 and the one or more second mounts 118 may be used to secure the pressure vessel 100 to a surface or some other component or structure in a larger system. For example, the one or more first mounts 116 and the one or more second mounts 118 may be used to secure the pressure vessel 100 to one or more other parts of a vehicle system. The one or more first mounts 116 and the one or more second mounts 118 may provide a stable base to register the pressure vessel 100 with respect to a structural frame, chassis, or the like, thereby preventing any movement or disgorgement of the pressure vessel 100 during use and/or transport (e.g., while the vehicle is in motion).

In the FIG. 17 example, in selected embodiments, the pressure vessel 100 may include a first end cap 120 and a second end cap 122 positioned opposite one another at opposite ends of the pressure vessel 100 in the axial direction 109b. More specifically, the first end cap 120 may be securely connected to the upper shell 110 (e.g., by welding or the like) at the first end 103. The second end cap 122 may be securely connected to the lower shell 112 (e.g., by welding or the like) at the second end 105. The first end cap 120 and the second end cap 122 may be similar (e.g., identical) in structure. In other embodiments, the upper shell 110 and the lower shell 112 are shaped to close off at the first end 103 and the second end 105, respectively, making the first end cap 120 and the second end cap 122 unnecessary. As such, in certain embodiments the pressure vessel 100 may be formed without the first end cap 120 and the second end cap 122.

In the FIG. 17 example, in certain embodiments, the lower shell 112 may include a first opening 124 and a second opening 126. The first opening 124 and the second opening 126 may be formed on a portion of the wall 102. The first opening 124 and the second opening 126 may provide locations for liquids and/or gases to pass into or out of the pressure vessel 100. In selected embodiments, the first opening 124 and the second opening 126 may be formed to support engagement therewith. For example, the first opening 124 and the second opening 126 may be formed with threads or the like that enable complementary structures such as valves, conduits, or the like to secure thereto in a sealed or leak-resistant manner.

Still referring to the example in FIG. 17, in selected embodiments, the body 101 may define a first inner volume 132 and a second inner volume 134 that are in fluid-separation from each other, such that the first inner volume 132 and the second inner volume 134 may operate independently with no direct exchange of gases or fluids between them. The body 101 may include a center column 130 that encloses the first inner volume 132. As such, the center column 130 defines a first inner volume 132 extending between the first end 103 and the second end 105. The center column 130 also serves as the barrier to separate the first inner volume 132 from the second inner volume 134. The wall 102 surrounds the center column 130 and defines an outer surface facing away from the center column 130. The center column 130 and the wall 102 enclose the second inner volume 134 and define the second inner volume 134. The second inner volume 134 is disposed annularly around, and fluidly separate from, the first inner volume. The first inner volume 132 may be smaller in size than the second inner volume 134. The utilization of two different sized cavities may allow for efficient use of gas energy in vehicle operations. The larger inner volume may be well-suited to handle high-demand tasks like driving brakes, while the smaller inner volume may be optimal for low-demand tasks like parking brakes.

In the FIG. 17 example, in certain embodiments, the body 101 may comprise internal ribs 136 arranged in the second inner volume 134. The internal ribs 136 may be tensile ribs, which experience tension loading when the pressure vessel 100 is charged or pressurized. The internal ribs 136 may extend axially from the first end 103 of the body 101 on the upper shell 110 approaching the welded seam 114. Similarly, the internal ribs 136 may extend axially from the second end 105 of the lower shell 112 approaching the welded seam 114. The internal ribs 136 in the upper shell 110 and the lower shell 112 may join together at the welded seam 114. Alternatively, the internal ribs 136 in the upper shell 110 and the lower shell 112 may not intersect and instead leave a gap where the internal ribs 136 extend. This gap provides a pathway for fluid or gas exchange between the upper shell 110 and the lower shell 112 and facilitates fluid exchange within the second inner volume 134.

In the FIG. 17 example, the first end cap 120 may include a top surface 138. The top surface 138 may include multiple and identical iterations of the sub-sections 140 that cooperate to form the top surface 138. The first end cap 120 may include outer ribs 142 positioned on an exterior of the top surface 138 and separate or delineate each of the sub-sections 140. Each of the outer ribs 142 may extend radially from a central portion of the first end cap 120 to a perimeter of the first end cap 120. The outer ribs 142 may increase the strength or stiffness of the first end cap 120 in the axial direction. As a result, the first end cap 120 may have greater resistance to bending in the axial direction. For example, when an elevated pressure (e.g., 5 MPa pressure) is applied in the axial direction, the first end cap 120 may retain its shape and avoid bulging or bowing out in the axial direction.

In selected embodiments, the first end cap 120 may include inner ribs 144 positioned on an interior of the top surface 138. Each of the inner ribs 144 may extend radially from a central portion of the first end cap 120 toward a perimeter of the first end cap 120. Like the outer ribs 142, the inner ribs 144 may increase the strength or stiffness of the first end cap 120 in the axial direction. As a result, due to the combination of the outer ribs 142 and the inner ribs 144, the first end cap 120 may have greater resistance to bending, bulging, or bowing out in the axial direction.

Referring now to FIGS. 1-11B an alternate pressure vessel 200 is shown and described below. In one example application, the pressure vessel 200 may be used in vehicles, for example transportation vehicles (e.g., passenger vehicles including cars, trucks, recreational vehicles, commercial vehicles, semi tractor trailer trucks, mass transit vehicles as well as autonomous vehicles). The pressure vessel 200 may be used in alternate applications as known by persons skilled in the art.

In transportation vehicles, for example passenger cars and trucks, the pressure vessel 200 may be used to contain or store pressurized air (i.e., air that is above atmospheric pressure) and selectively provide or supply the pressurized air to support other vehicle systems. Other forms of gasses and fluids may be stored. In one example, the pressure vessel 200 is in pressurized gaseous or air flow communication with a brake system of the transportation vehicle to assist in the braking or deceleration of the vehicle. Alternately, the pressure vessel 200 may be used to supply pressurized air to lock or engage the braking system to continue to apply the braking system (e.g., a parking brake). Other example transportation vehicle applications include the pressure vessel 200 in pressurized gaseous or air flow communication with the active suspension of a transportation vehicle (e.g., providing pressurized air for the shock absorbers or struts, for example, dynamic suspension control, ride height, and/or ride and drive handling of the vehicle). The pressure vessel 200 may be used with other systems and subsystems in vehicles and transportation vehicles as known by persons skilled in the art. The pressure vessel 200 has other applications besides vehicles as known by persons skilled in the art.

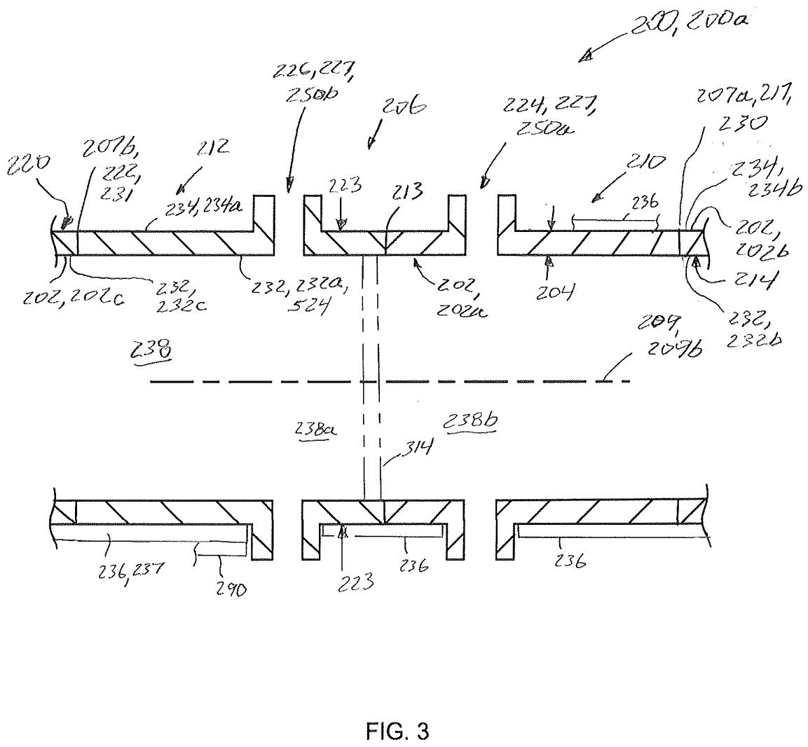

Referring to FIGS. 1A, 1B and 3, an example of pressure vessel 200 is shown. In the example, the pressure vessel 200 includes a wall 202 which defines the external shape and the internal volume or storage capacity of the vessel 200. In one example, the wall 202 is formed from a polymeric material. Examples of the polymeric material may include nylon PA6 GFxx (i.e., polyamide, grade 6, with glass fiber reinforcement or other fiber filled at a percentage of “xx” by volume). Other examples of polymeric materials include PP GFxx (i.e., polypropylene with glass fiber reinforcement or other fiber filled), or HDPE GFxx (i.e., high density polyethylene with glass fiber or other fiber filled). In the examples, the “xx” percentage of glass fiber reinforcement or other reinforcement fiber fill may be in a range of 20%-50% by volume. In one example, the reinforcing fibers may be glass fibers (“GF”), carbon fibers (“CF”), or other reinforcing fibers as known by persons skilled in the art. In one example, the reinforcing fibers are continuous. It is understood that the “xx” percentage may be above or below this range to suit the particular application and performance requirements as known by persons skilled in the art, and the percentage (%) may be based on a metric other than volume as described. It is further understood that the type of reinforcing fiber (e.g., glass fiber or carbon fiber) may vary to suit the particular application and performance requirements as known by persons skilled in the art. Alternate polymeric materials than the examples described above, as well as other materials, may be used to suit the particular application and performance requirements as known by persons skilled in the art.

Other polymeric materials may be used to suit the application and performance requirements as known by persons skilled in the art. In one example, the wall 202 is formed from injection molding. Other manufacturing processes may be used as known by persons skilled in the art. The wall 202 may be made from other materials including composites (e.g., carbon fiber reinforced resin) and other materials as known by persons skilled in the art.

In one example as best seen in FIG. 3, the wall 202 has a wall thickness 204 in the range of 2.5 millimeters (mm) and 4.5 millimeters (mm). The wall thickness 204 of the pressure vessel 200 may take other values, both higher or lower, depending on the application, the configuration of the pressure vessel, the material used, and performance requirements as known by persons skilled in the art.

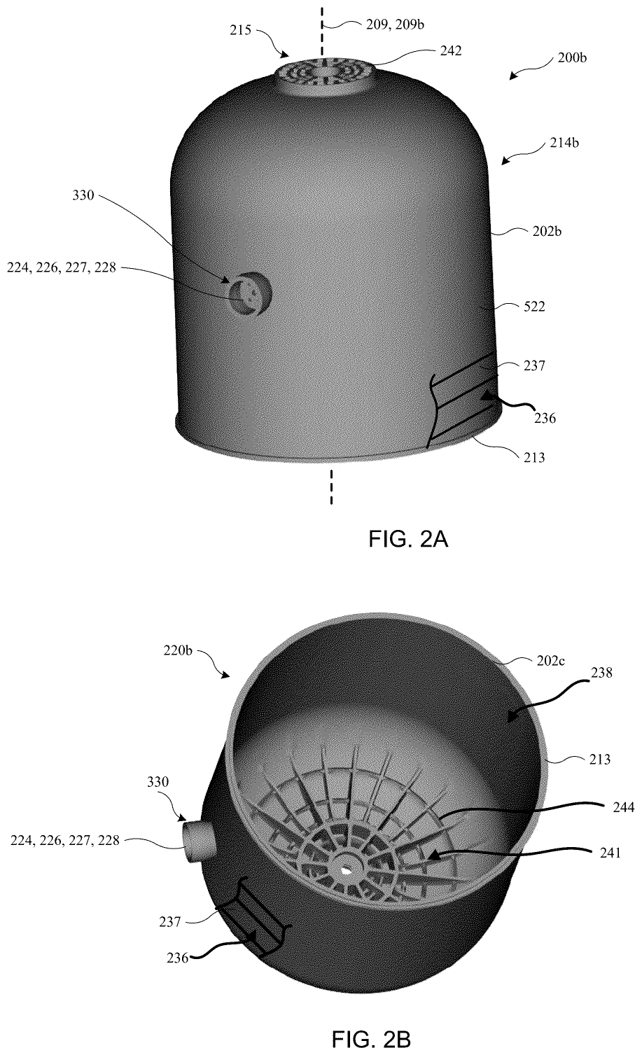

The pressure vessel 200 includes a first end 203 and a second end 205 spaced in an axial direction 209b along an axis 209 as generally shown in FIGS. 1 and 2. In one example as shown in the FIGS. 1A, 1B example, the pressure vessel 200 includes a central shell 206 having a first end 207a and a second end 207b spaced in the axial direction 109b. In one example the central shell 206 is cylindrical or tubular shaped and includes an inner volume as discussed further below. The central shell 206 includes a wall 202a formed from the polymeric material extending between the first end 207a and the second end 207b. In one example, the wall 202a is the same or substantially similar to the wall 202 of the pressure vessel 200. In an alternate example, the wall 202a may take other shapes, sizes and configurations, and be made from different materials, than described for the wall 202 for pressure vessel 200.

In one example of pressure vessel 200 shown in FIGS. 1A, 1B and 3, the central shell 206 includes an upper shell 210 having a first end 207a (i.e., the same end as the first end 207a of the central shell 206 described above) and a second end 240a spaced in the axial direction 209b. The central shell 206 also includes a lower shell 212 having a first end 207b (i.e., the second end 207b as described for the central shell 206) and a second end 240b spaced in the axial direction 209b as generally shown in FIG. 1A. In the example, the second end 240b of the lower shell 212 is complimentary to and is connected to the second end 240a of the upper shell at a central seam 213. Connection of the upper shell 210 to the lower shell 212 at the central seam 213 may be by welding wherein the polymeric material is locally melted and fused with the polymeric material of the upper shell 210 opposing the lower shell 212 (e.g., friction welding, hot plate welding, hot gas welding, ultrasonic welding). Alternate processes and techniques to securely, fixedly and sealingly connect the upper shell 210 to the lower shell 212 may be used as known by persons skilled in the art.

In an alternate example (not shown), the central shell 206 is a single piece shell between the first end 207a and the second end 207b (i.e., there is no central seam 213). In other words, the central shell 206 does not include the upper shell 210 as a separate piece from the lower shell 212.

Still referring to FIGS. 1A, 1B and 3, the pressure vessel 200 includes a first end cap 214 having a first end 215 (i.e., the first end 203 of the pressure vessel 200), and a distal end 217 spaced in the axial direction 109b as generally shown. In the example shown, the first end 207a of the upper shell 210 is connected to the distal end 217 of the first end cap 214 at the first end cap seam 230. In an alternate example described above (not shown) where the central shell 206 is a single piece shell, the distal end 217 of the first end cap 214 connects to the first end 207a of the central shell 206. The first end cap 214 may be connected to the central shell 206 by the methods described above for connection of the upper shell 210 to the lower shell 212.

In one example as best seen in FIG. 3, the central shell 206, or alternately the upper shell 210 and the lower shell 212, includes an outer diameter 223. In one example, the distal end 217 of the first end cap 214 and the distal end 222 has an outer diameter equal to the outer diameter 223 of the central shell 206 (e.g., as shown in the examples in FIGS. 1A and 2A).

In the example shown in 1A and 3, the first end cap 214 includes a wall 202b formed from the polymeric material extending between the first end 203 and the distal end 217. The wall 202b of the first end cap may be made from the same polymeric material, include the same wall thickness 204, and be made by the same manufacturing processes as the wall 202 and 202a described above. Alternate materials, configurations, dimensions, sizes, shapes, and manufacturing processes for the first end cap 214 may be used to suit the application and performance specifications as known by those skilled in the art.

Referring to the example shown in FIGS. 1A, 1B and 7, the first end cap 214 further includes a first mount 216 positioned at the first end 215 of the first end cap 214 configured to mount the pressure vessel 200 to an object. In one example, the object is a vehicle or transportation vehicle as described above. In one example, the first mount 216 may connect the pressure vessel 200 to a structural member (e.g., a steel or metallic body or composite structure or component) of the vehicle.

Still referring to the FIGS. 1A, 1B and 3 example, the pressure vessel 200 includes a second end cap 220 having a first end 221 and a distal end 222 spaced in the axial direction 109b as generally shown. In the example shown, the first end 207b of the lower shell 212 is connected to the distal end 222 of the second end cap 220 at the second end cap seam 231 as generally shown in FIG. 1A. In an alternate example described above (not shown) where the central shell 206 is a single piece shell, the distal end 222 of the second end cap 220 connects to the second end 207b of the central shell 206. The second end cap 220 may be connected to the central shell 206 by the methods described above for connection of the upper shell 210 to the lower shell 212.

In the example shown, the second end cap 220 includes a wall 202c formed from the polymeric material extending between the first end 221 and the distal end 222. The wall 202c of the second end cap 220 may be made from the same polymeric material, include the same wall thickness 204, and be made from the same manufacturing processes as the wall 202a and the wall 202b described above. Alternate materials, configurations, dimensions, sizes, shapes, and manufacturing processes may be used for the second end cap 220 to suit the application and performance specifications as known by those skilled in the art.

Referring to the example shown in FIGS. 1A, 1B and 7, the second end cap 220 further includes a second mount 218 positioned at the first end 221 of the second end cap 220 configured to mount the pressure vessel 200 to an object as described above for the first mount 216.

As best seen in the FIG. 3 example, the wall 202a of the central shell 206, the wall 202b of the first end cap 214, and the wall 202c of the second end cap 220 each includes an inner surface 232a, 232b, and 232c, respectively, and an outer surface 234a, 234b, and 234c, respectively. The inner surface 232a of the central shell 206, the inner surface 234b of the first end cap 214, and the inner surface 234c of the second end cap 220 forming an inner volume 238 of the pressure vessel 200. In the above example wherein the central shell 206 includes the upper shell 210 and the lower shell 212 (e.g., FIGS. 1A, 1B and 3), the inner surface 232a is divided between the upper shell 210 and the lower shell 212. In one example of the pressure vessel 200 suitable for application for a brake system of a transportation vehicle, the inner volume 238 may be in a range of 30 liters (L) to 60 liters (L). The inner volume 238 may take alternate volume values, both higher or lower, outside this range. In one example of the pressure vessel 200, the pressurized air stored in the inner volume 238 may be in a range of 150 pounds per square inch (psi) and 200 pounds per square inch (psi). It is understood that the pressurized air may be at different pressure value, above or below this range, to suit the particular application or performance specifications as known by persons skilled in the art.

Referring to FIGS. 2A and 2B, an alternate pressure vessel 200b is shown. In the example, the pressure vessel 200b includes the first end cap 214a and a second end cap 220a which extend axially parallel to the longitudinal axis 209 and connect together at the central seam 213. In the example, there is no separate central shell 206 or the separate upper shell 210 and the lower shell 212 as described for FIGS. 1A, 1B and 3. In the example shown in FIGS. 2A and 2B, other than the extended axial length and connection at the central seam 213, the first end cap 214a is similarly constructed as described for first end cap 214, the second end cap 220a is similarly constructed as described for the second end cap 220, and structures or features described for the central shell 206 may be included in the first end cap 214a and the second end cap 220a (e.g., wall 202b, 202c; first end 215, 221; distal end 217, 222; inner surface 232b, 232c; outer surface 234b, 234c; wall thickness 204; annular flange 330; material; and manufacturing process as generally described and generally shown in FIGS. 1A, 1B and 3).

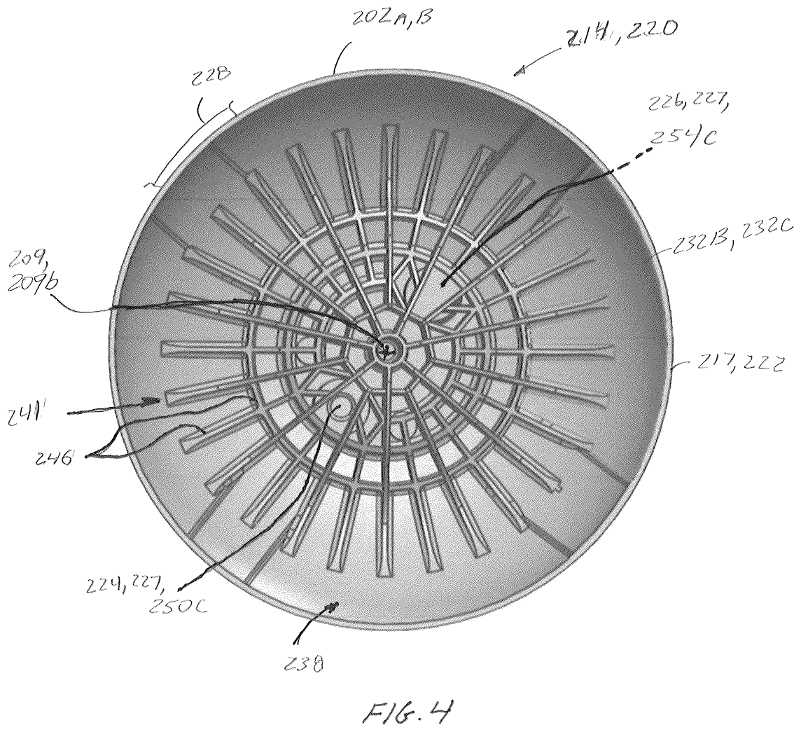

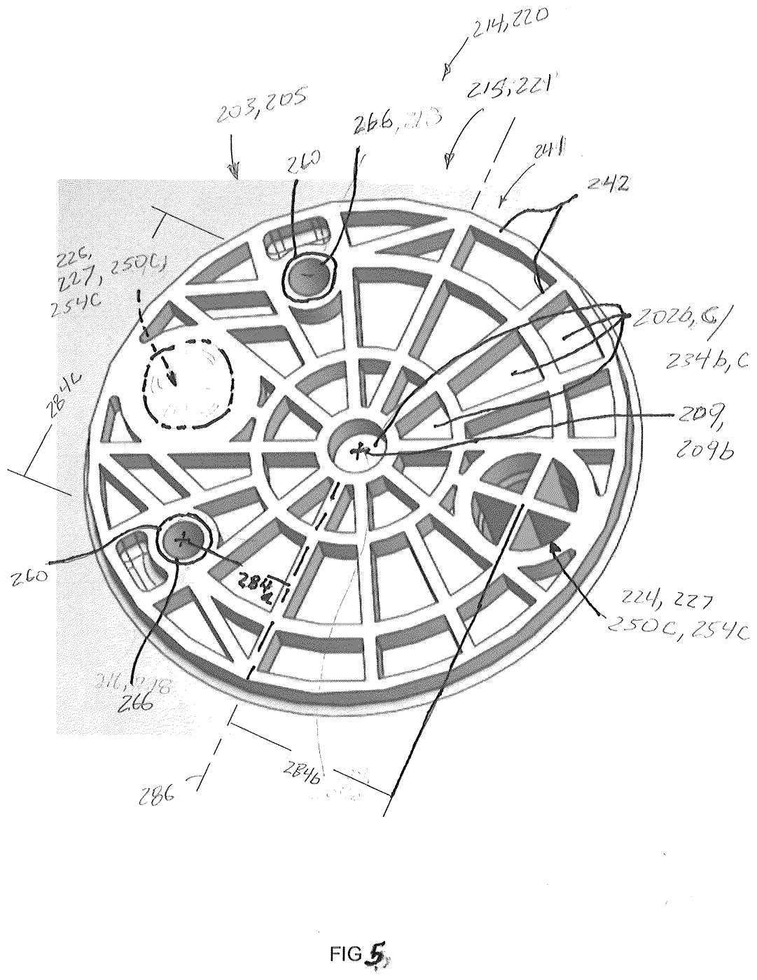

The first end cap 214a and the second end cap 220a may include the reinforcing ribs 241 as described and as shown in FIG. 2A (e.g., the outer ribs 242 and/or the inner ribs 244 as generally described and generally shown in FIGS. 4-6). The first end cap 214a and the second end cap 220a may include the first mount 216 and the second mount 218 as generally described above and generally shown in FIGS. 1A, 1B, and 6-8). In an alternate example, the first end cap 214a and the second end cap 220a may not include the first mount 216 and the second mount 218. In one example, the pressure vessel 200b includes the external sheath 236 (e.g., shown in one non-limiting example as the reinforcing fibers 237) as described above and further below.

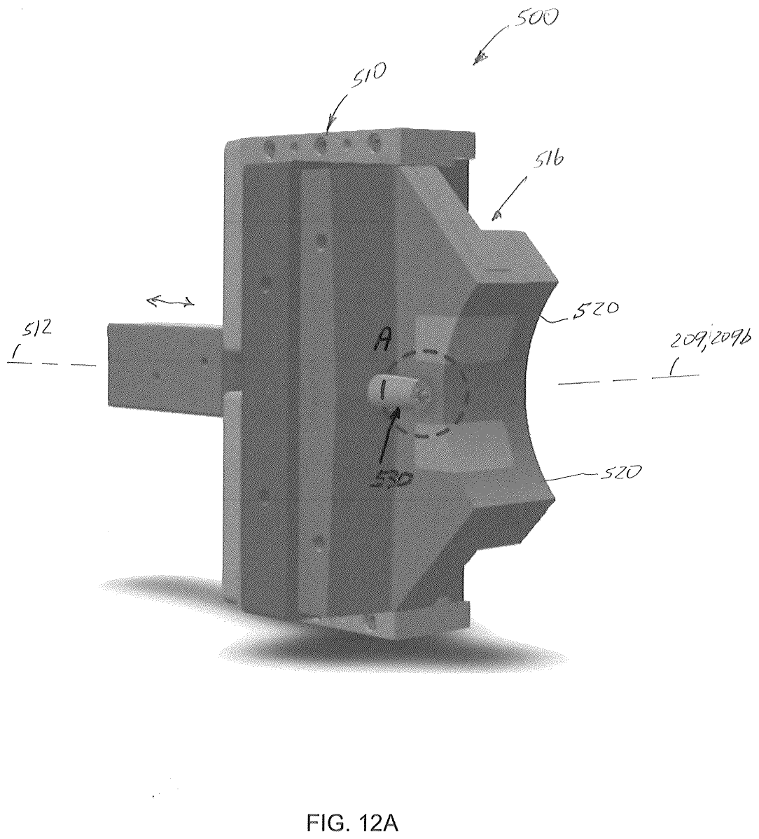

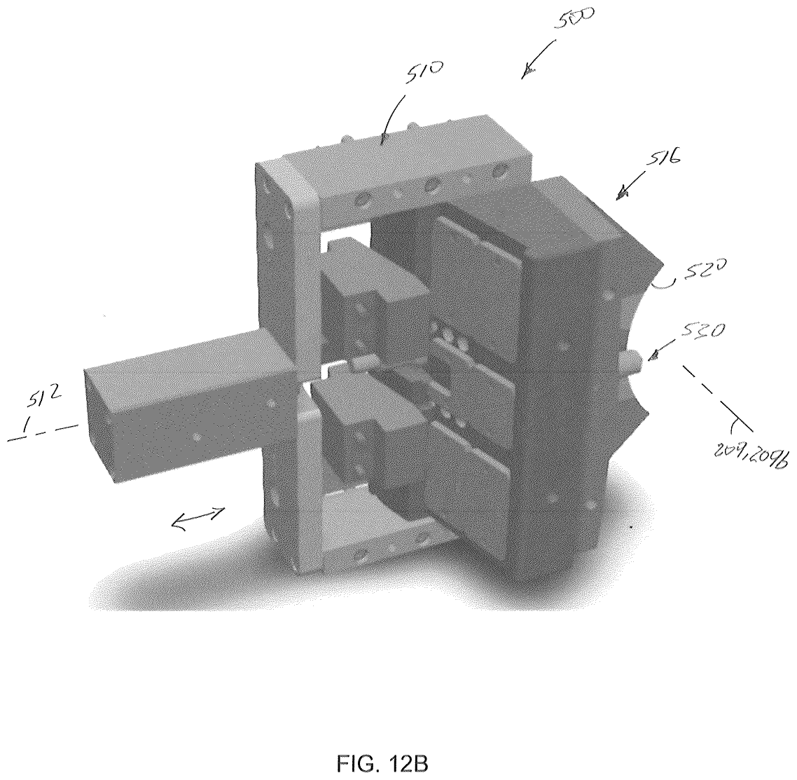

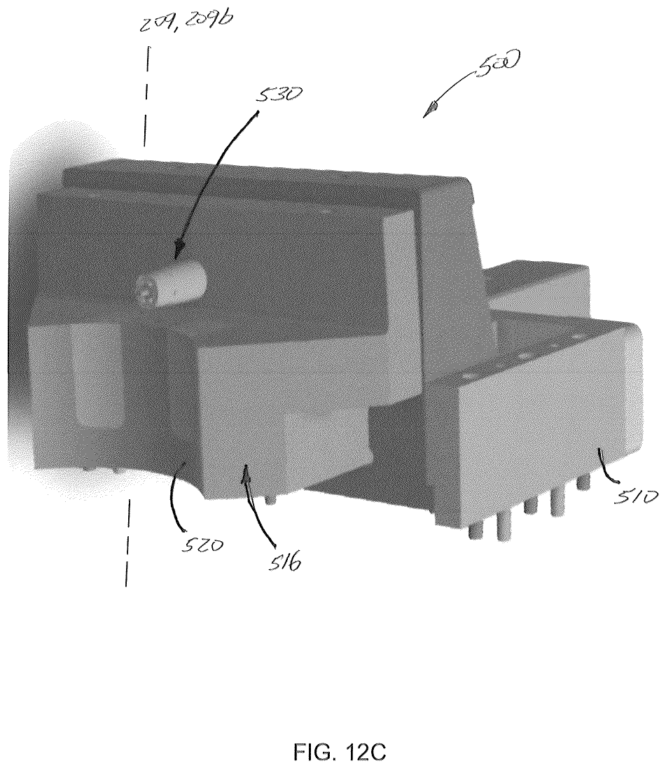

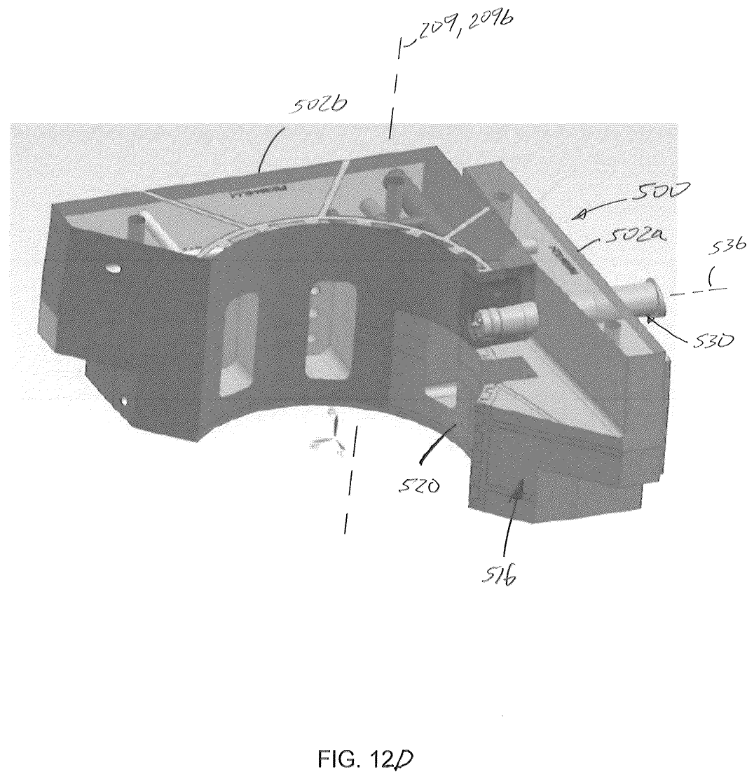

As shown in the FIGS. 2A and 2B example, the pressure vessel 200b includes one of the first opening 224 or the second opening 226 in the wall 202b and the wall 202c in the form of the air port 227 as described above, or in the form of the drain port 228 as generally shown. As described above for the pressure vessel 200, the reinforcing ribs 241 (e.g., the inner ribs 244 and the outer ribs 242 at the first ends 215, 221) may include the first opening 224 and/or the second opening 226 in the wall 202b and the wall 202c in the form of the air port 227 as described above, or in the form of the drain port 228 as described above. The pressure vessel 200b may include one or more of the inserts 350 discussed further below and illustrated in FIGS. 9-11B. The pressure vessel 200b may further be made using the mold cavity dies 502a-502e, the mold cavity die 500, and/or the method for inserting a reinforcement in an injected molded part 600 as described below and illustrated in FIGS. 12-16. It is understood that the pressure vessel 200b may take other forms, configurations, shapes, sizes, features, mounting devices, and/or use alternate materials and/or manufacturing processes to suit the particular application and performance specifications as known by persons skilled in the art.

For convenience of description, references made hereafter to pressure vessel 200 include the pressure vessel 200a (described below) and the pressure vessel 200b unless otherwise noted. For convenience of description, references made hereafter to the first end cap 214 and the second end cap 220 (shown in FIGS. 1A, 1B and 3) include the first end cap 214a and the second end cap 220a (as shown in FIGS. 2A, 2B) unless otherwise noted.

Referring to the FIGS. 1A, 1B, 2A, 2B, and 3 example, the pressure vessel 200 includes an external sheath 236 substantially surrounding the outer surface 234 of the central shell 206 (shown in the FIGS. 1A, 1B example), and/or the first end cap 214, and the second end cap 220.

In one example the external sheath 236 includes reinforcing fibers 237 (or filaments) embedded in a medium. In one example, the medium is an epoxy resin (e.g., resin component and a hardener component) and the reinforcing fibers 237 include a fiber strands, a fiber web, a fiber mat, or a fiber tape (e.g., a “tow”) that is coated (e.g., impregnated) by the epoxy resin before applying or wrapping the fiber strands around the outer surface 234 of the pressure vessel 200, 200a, 200b (e.g., the first end cap 214, the second end cap 220, and the central shell 206 (if used)). In one example, the reinforcing fibers 237 in the form of the fiber strands include filaments or reinforcing fibers, for example glass fibers or carbon fibers, that are coated or exposed to the epoxy resin that serves as a matrix or binder for the fiber stands. In one example the fiber stands impregnated with the epoxy resin are wound around or applied to the outer surface 234 of the pressure vessel 200, 200b, and then the wound pressure vessel is placed in a heating source which heats and cures the epoxy resin forming a hard and strong reinforcement around the pressure vessel 200, 200a, 200b. Alternate mediums, resins, and reinforcing fibers 237 can be used to suit the particular application and performance requirements as understood by persons skilled in the art.

In an alternate example, the external sheath 236 is a reinforced tape. In one example, the reinforced tape includes the reinforcing fibers 237 embedded or impregnated in the medium in the form of a thermoplastic tape (e.g., in the base material, resin, or polymer matrix of the tape) and oriented parallel to a length of the tape. The reinforcing fibers 237 may be made from glass fiber, carbon fiber, polyester, or other materials, and the fibers may be short, long, or continuous to suit the particular application and performance specifications. In an alternate example, the reinforcing fibers 237 may be configured in an aligned orientation that is not along the length of the tape. In an alternate example, the reinforcing fibers 237 may be configured in a non-unidirectional way, for example randomly oriented or dispersed in the tape. In an alternate example, the reinforcing of the tape may include reinforcing materials other than fibers. In an alternate example, the tape may not include reinforcing fibers or other reinforcing materials.

In one example, the reinforced tape is a thermoplastic unidirectional tape wherein the tape (e.g., the base material or resin) is made from polyethylene, polypropylene, nylon, polyether ether ketone (PEEK), polyamide, or other materials suitable for the particular application or performance specifications as known by persons skilled in the art. In one example the thermoplastic unidirectional tape is made in the range from 50% to 60% glass fibers or carbon fibers by volume embedded in the polymer matrix of Nylon, Polyester, PEEK and other materials and alternate materials noted above. In an alternate example, the reinforced tape may be made from materials or compositions other than thermoplastic materials, for example, thermoset materials (e.g., glass fibers or carbon fibers impregnated, wetted or coated in a thermoset medium (e.g., epoxy resin)) prior to wrapping around the pressure vessel as generally described above. Other forms, materials, or composition polymers may be used for the reinforcing fibers embedded in the medium, or the external sheath 236, to suit the application or performance specifications as known by persons skilled in the art.

In one example of an application of the external sheath 236, following connection of first end cap 214 to the second end cap 220, or, alternately, following connection of the upper shell 210 to the lower shell 212 at the central seam 213, connection of the first end cap 214 to the upper shell 210 at the first end cap seam 230, and connection of the second end cap 220 to the lower shell 212 at the second end cap seam 231, the external sheath 236 (e.g., the reinforced fibers 237 coated with the epoxy resin is wound around substantially all of the outer surface (i.e., 234a, 234b, and 234c) of the pressure vessel 200 and is configured and serves as an external reinforcement of the wall 202 to eliminate or reduce expansion or deformation of the wall 202 and the pressure vessel 200 when the inner volume 238 is subject to pressurized air. In one example, one layer or multiple layers (e.g., in partially angled and overlapping orientation) of the reinforced fibers 237 embedded in the medium may be used. In one example, the reinforced tape 237 is not applied in areas of openings in the wall 202 or external reinforcing ribs (both discussed further below).

In an alternate example (not shown), the external sheath 236 may not be used and a plurality of the external ribs 108, and/or patterns of external ribs 108, as shown in FIG. 17 and described above may be used.

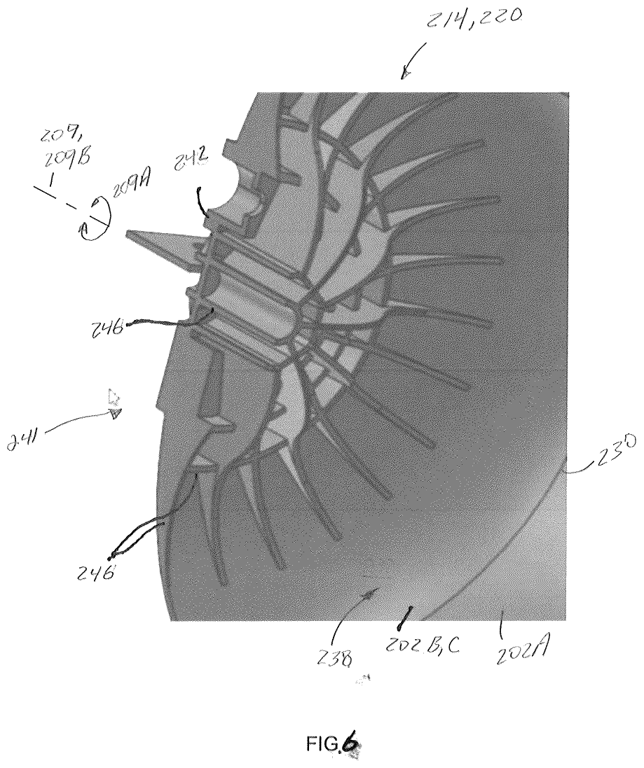

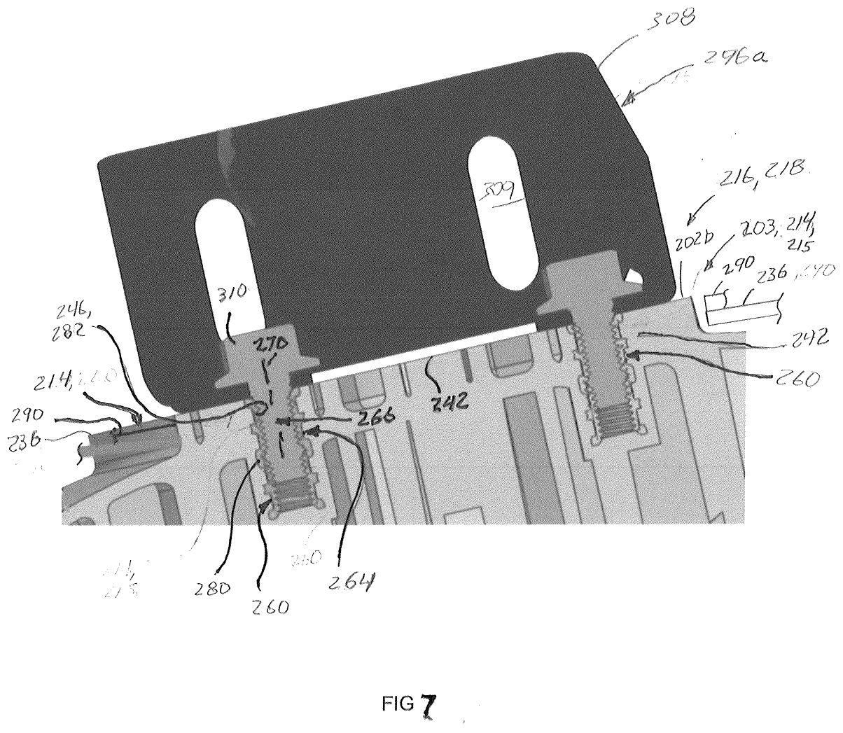

Referring to the FIGS. 1B, 2B, 4, 5 and 6 examples, the first end cap 214 and the second end cap 220 each include reinforcing ribs 241 integrally formed (i.e., monolithic as described above) or integrally molded (e.g., overmolded) in the wall (i.e., 202b and 202c) at the first ends (i.e., 215, 221), respectively. In one example, the reinforcing ribs 241 include inner ribs 244 connected to (i.e., extending from) the inner surface 232b of the first end cap 214 and the inner surface 232c of the second end cap 220 as generally shown in the example in FIGS. 4 and 6. In one example as best seen in FIG. 5, the reinforcing ribs 241 also include outer ribs 242 connected to (i.e., extending from) the outer surface 234b of the first end cap 214 and the outer surface 234c of the second end cap 220. As best seen in the FIG. 6 example, the inner ribs 244 and the outer ribs 242 are integrally molded with the wall (i.e., 202b, 202c). In one example (not shown), the first end cap 214 and/or the second end cap 220 may include only inner ribs 244, only outer ribs 242, or no inner ribs 244 or outer ribs 242.

In one example, the inner ribs 244 are connected to the inner surface 232b, 232c of the wall of the first end cap 214 and the second end cap 220, respectively. The outer ribs 242 are connected to the outer surface 234b, 234c of the wall of the first end cap 214 and the second end cap 220, respectively. In one example, the outer ribs 242 have a rib configuration different from the inner ribs 244. In one example, the outer ribs 242 are integrally molded with the wall 202 and the inner ribs 244.

Referring to the FIGS. 4 and 6 example, the inner ribs 244 may include one or a plurality of circumferential ribs forming a circumferential pattern extending circumferentially (i.e., in a circumferential direction 209a) about the longitudinal axis 209 and may include one or a plurality of radial ribs forming a radial pattern (i.e., extending radially outward away from the longitudinal axis 209) as generally shown. As best seen in the FIG. 6 example, the inner ribs 244 may extend axially along or parallel to the longitudinal axis 209 into the inner volume 238 as generally shown. In one example (not shown) the inner ribs 244 may include only radial ribs, only circumferential ribs, or no inner ribs 244 may be used. As described above for the outer ribs 242 (shown and described as external ribs 108 in FIG. 12), the inner ribs 244 may take alternate numbers of ribs, forms, orientations, angles, intersections at angles, configurations and/or patterns (e.g., diamond pattern, honeycomb pattern etc., or combinations thereof as described above) to suit the particular application, the polymer material used for wall 202b, 202c, and the performance specifications as known by persons skilled in the art.

Referring to the FIGS. 1B, 2A and 5 example of the pressure vessel 200, the outer ribs 242 may include radial ribs and circumferential ribs as described above for the inner ribs 244 as generally shown. As described for the inner ribs 244, the outer ribs may take alternate numbers of ribs, forms, orientations, angles, intersections at angles, configurations and/or patterns (e.g., diamond pattern, honeycomb pattern etc., or combinations thereof as described above) to suit the particular application, the polymer material used for wall 202b, 202c, and the performance specifications as known by persons skilled in the art. In one example, the reinforcement ribs 241, for example the inner ribs 244 and/or the outer ribs 242, include a thickness (i.e., wall thickness) in a range of 1 millimeter (mm) and 3 millimeters (mm). It is understood that the thickness of the reinforcing ribs 241 may vary, both higher or lower, than this range depending on the application and the performance requirements of the pressure vessel 200 as known by persons skilled in the art.

Referring to the example shown in FIGS. 1A, 1B, 2A, 2B and 5, the pressure vessel 200 includes a first opening 224 and a second opening 226. In one example, the wall (e.g., 202, 202a, 202b, 202c) in at least one of the central shell 206 (if configured in the central shell 206 configuration), the upper shell 210, the lower shell 212, the first end cap 214, or the second end cap 220 defines at least one of the first opening 224 through the wall in communication with the inner volume 238 and/or the second opening 226 through the wall in communication with the inner volume 238. In one example, the first opening 224 and the second opening 226 include, or are configured as, an air port 227 configured to allow pressurized air to enter or exit the inner volume 238 through the air port 227. In one example (not shown), the first opening 224 and the second opening 226 may be formed by the wall 202 without reinforcing ribs 241 (described above and below).

As shown in the example in FIGS. 1A, 1B and 5 (and alternately shown in the first end cap 214a and the second end cap 220a shown in FIGS. 2A, 2B) each of the upper shell 210 and the lower shell 212 include the first opening 224 and the second opening 226. In one example, each of the first opening 224 and the second opening 226 is configured as an air port 227 configured to allow pressurized air to enter or exit the inner volume 238 through the air port 227. In one example, one or more of the air ports 227 can serve as an air inlet 250 allowing pressurized air to enter the inner volume 238, or an air outlet 254 allowing pressurized air to exit the inner volume 238. In one example best seen in FIGS. 1A and 3, the upper shell 210 includes two air ports 227, one of the air ports 227 configured as the air inlet 250A, and the other air port 227 configured as the air outlet 254A to the inner volume 238. The lower shell 212 may be similarly configured with air ports 227, the air inlet 250B and an air outlet 254B as the upper shell 210 as described.

In an alternate example (not shown), the upper shell 210 may include one air port 227 (i.e., a first opening 224 or a second opening 226 configured as an air inlet 250 or an air outlet 254) and the lower shell 212 may include one of the air port 227 (i.e., a first opening 224 or a second opening 226 configured as an air inlet 250 or an air outlet 254). In one example, the upper shell 210 includes the air inlet 250 and the lower shell 212 includes the air outlet 254. In one example of the pressure vessel 200 that includes a dividing wall (discussed below) forming a first inner volume and a second inner volume (discussed below), each of the first inner volume and the second inner volume may include a first opening 224 and a second opening 226, wherein there is an air inlet 250 and an air outlet 254 for each of the first inner volume and the second inner volume. In one example (not shown) the central shell 206, and the upper shell 210 and a lower shell 212, do not include a first opening 224 or a second opening 226 that is configured as an air port 227.

As shown in the FIGS. 2A, 2B example, each of the first end cap 214b and the second end cap 220a, may include the first opening 224 or the second opening 226 (e.g., in the form of the air port 227), or the drain port 228. In an alternate example, only one of the first end cap 214a or the second end cap 220a may include the first opening 224 or the second opening 226 (e.g., in the form of the air port 227) or the drain port 228. In an alternate example, the first end cap 214a and the second end cap 220a do not include the first opening 224, the second opening 226, the air port 227, or the drain port 228.

As best seen in the FIGS. 5 and 4 example, at least one of the first opening 224 or the second opening 226 are positioned in the first ends 215, 221 of at least one of the first end cap 214 or the second end cap 220 (e.g., including the examples shown in FIGS. 2A, 2B). As generally described above for the upper shell 210 and the lower shell 212, each of the first end cap 214 and the second end cap 220 may define the first opening 224 and the second opening 226, may include one of the first opening 226 or one of the second opening 226, or may not include the first opening 224 or the second opening. In the example shown in FIG. 5, the first end cap 214 and the second end cap 220 each define the first opening 224, configured as an air port 227, and can serve as an air inlet 250C or an air outlet 254C. In the FIG. 5 example, the second opening 226 (shown in phantom line) is shown closed or blocked by the wall (i.e., the polymeric material) preventing the passage of air into or exiting from the inner volume 238 through a second opening 226. In one example of the illustrated configuration, the first end cap 214 may include the air inlet 250C and the second end cap 220 may include the air outlet 254C (or vice versa).

In an alternate example, one of the first end cap 214 or the second end cap 220 may include one of the first opening 224 or the second opening 226, and the other of the first end cap 214 or the second end cap 220 may not include either the of the first opening 224 or the second opening 226. In the examples, the first opening 224 and/or the second opening 226 may be an air port 227 and be configured as an air inlet 250 or an air outlet 254 as described above for the central shell 206, and the upper shell 210 and the lower shell 212.

Referring to the FIGS. 1A and 1B example, the pressure vessel 200 may include at least one drain port 228 (two shown) configured to allow the release of liquid (e.g., water in the form of condensation) that may form or gather in the inner volume 238 during use of the pressure vessel 200. In an alternate example, the drain port 228 may be used or configured to release the pressurized air from the inner volume 238. In one example as shown in FIGS. 1A and 1B, the drain port 228 includes an opening (not shown) in communication with the inner volume 238. In one example, the drain port 228 includes a valve (not shown) which is normally in a closed position preventing the liquid or pressurized air in the inner volume 238 from exiting the inner volume 238. In one example of the pressure vessel 200, the first opening 224 and the second opening 226 include a valve (not shown) as described above. In an alternate example, when the first opening 224 and the second opening 226 are installed and connected to the vehicle (e.g., by conduits or hoses), the inner volume 238 can contain the pressurized air without leaking the pressurized air from the inner volume 238.

In the example shown in FIGS. 1A and 1B, the drain port 228 is included in the wall 202a of the upper shell 210 and the wall 202a of the lower shell 212. In an alternate example (not shown) the drain port 228 may alternately, or additionally, be included in the first end cap 214 and/or or the second end cap 220. In one example (not shown), the drain port 228 is not included in the pressure vessel 200. It is understood that the pressure vessel 200b shown in FIGS. 2A, 2B may include the at least one drain port 228 as described above for pressure vessel 200. Alternate constructions, configurations, sizes, shapes, positions, orientations, and numbers of the drain port 228 may be used to suit the particular application as known by persons skilled in the art.

In the example as best seen in FIGS. 1B, 2A, 2B, 4 and 5, the reinforcing ribs 241 in at least one of the first end cap 214 or the second end cap 220 define at least one of the first opening 224 or the second opening 226 in communication with the inner volume 238 of the pressure vessel 200. As described above, the first opening 224 and/or the second opening 226 may be configured as an air port 227, and either as an air inlet 250 or an air outlet 254. In one example, the inner ribs 244 and the outer ribs 242 in the first end cap 214 and the second end cap 220 are oriented in cooperation to each define the at least one first opening 224 or the second opening 226 in communication with the inner volume 238 of the pressure vessel 200. As generally described above, in one example, the at least one first opening 224 or the second opening 226 is an air port 227 configured to allow pressurized air to enter or exit the inner volume 238 through the air port 227. In one example, the air port 227 of the first opening 224 is configured as an air inlet 250 configured to allow pressurized air to enter the inner volume 238 and the air port 227 of the second opening 226 is configured as an air outlet 254 to allow pressurized air to exit the inner volume 238.

In one example (not shown), the first end cap 214 may include a first opening 224, a second opening 226, a first opening 224 and a second opening 226, or may not include a first opening 224 or a second opening 226. In one example (not shown), the second end cap 220 may include a first opening 224, a first opening 224 and a second opening 226, or may not include a first opening 224 or a second opening 226. In the example where the first end cap 214 and/or the second end cap 220 does not include a first opening 224 or a second opening 226, the wall (i.e., 202b or 202c) closes off the first end cap 214 and the second end cap 220, respectively, preventing the release or exit of pressurized air from the inner volume 238.

In one example (not shown) a valve in communication with an electronic controller of the vehicle is in communication with the air port 227 to selectively allow the pressurized air to enter or exit the inner volume 238 through the air port 227.

Referring to the FIGS. 1A, 5 and 7 example of the pressure vessel 200, an example of the first mount 216 positioned in the first end 215 of the first end cap 214 is shown. In one example as best seen in FIG. 7, the first mount 216 includes a mount insert 260 engaged with the wall 202b of the first end cap 214, a fastener 310 engaged with the mount insert 260 of the first end cap 214, and a first mounting bracket 296a connected to the mount insert 260 of the first end cap 214 by the fastener 310. The second mount 218 is positioned at the first end 221 of the second end cap 220 and similarly includes a mount insert 260 engaged with the wall 202c of the second end cap 220, a fastener 310 engaged with the mount insert 260 of the second end cap 214, and a second mounting bracket 296b connected to the mount insert 260 of the second end cap 214 by the fastener 310.

In one example, the mount insert 260 is integrally molded (e.g., overmolded) into the wall of the first end cap 214 and the second end cap 220 during the molding (e.g., injection molding) or manufacturing of the first end cap 214 and the second end cap 220. In one example as shown in FIGS. 5 and 7, the mount insert 260 is integrally molded into the reinforcing ribs 241, for example the outer ribs 242, of the first end cap 214 and is integrally molded into the reinforcing ribs 241, for example the outer ribs 242, of the second end cap 220.

In an alternate example, the mount insert 260 may be inserted into an aperture (not shown) preformed into the wall 202b and fixedly secured to the wall 202b by devices or methods (e.g., adhesive, or heating of the mount insert 260 and/or the wall 202a or the reinforcing ribs 241) known by persons skilled in the art. In one example, the fastener 310 is a threaded bolt. In one example, the threaded bolt is made from an aluminum alloy which is suitable for use in the example wherein the mount insert 260 is made from aluminum. Alternate types of fasteners and the materials for those fasteners (e.g., steel or stainless steel) for fastener 310 may be used as known by persons skilled in the art.

Still referring to the FIG. 7 example, the mount insert 260 for the first mount 216 and the mount insert 260 for the second mount 218 each include a body 264 extending along an axis 270. The mount insert 260 further includes an inner surface 272 defining a mounting hole 266 along the axis 270, and an outer surface 274 defining a radial flange 280 configured to prevent rotation of the mount insert 260 about the axis 270 and prevent axial movement of the mount insert 260 parallel to the axis 270 relative to the wall 202b. In one example, the inner surface 272 includes threads 282 to threadingly engage the fastener 310. In the example shown in FIGS. 1B, 5 and 7, the reinforcing ribs 241, for example the outer ribs 242, provide sufficient polymeric material to provide structure to secure the mount insert 260. Additional ribs or configurations of ribs of the outer ribs 242 can be used for reinforcement of the wall 202b in the area of the mount insert 260. In one example described further below, the external sheath 236 may be positioned or applied in the local area around or adjacent to the outer ribs 242 and/or the mount insert 260 to reinforce the wall 202b.

In one example, the mount insert 260 is formed from an aluminum alloy which provides high strength and corrosion resistance. Alternate materials including other metallic materials (e.g., stainless steel, steel), and other materials suitable for the particular application and performance specifications may be used as known by persons skilled in the art. It is also understood that alternate designs, configurations, shapes, sizes and features for the mount insert 260 may be used as known by persons skilled in the art. In one example (not shown), the mount inserts 260 are not used. Alternate devices or components other than the mount insert 260 may be used to provide a secure mounting structure in the wall for the first mount 216 and/or the mounting bracket 296a, 296b (e.g., increased thickness or mounting bosses integrally molded in the polymeric material, integrally molded metal tapping plates in the wall etc.). The second mount 218 is similarly constructed and positioned as described for the first mount 216.

In one example, the external sheath 236 is locally increased or strengthened in a local area 290 surrounding the outer ribs 242 (as shown) or in the local area surrounding the mount insert 260 to provide additional strength in the wall 202b to support the mount insert 260. In one example, additional layers of the reinforced tape 237 may be locally applied in the area of the outer ribs 242 and/or in the local area around the mount inserts 260. In another example, the external sheath 236 is locally increased or strengthened (e.g., additional layers applied) in an area of the wall around or near the first opening 224 and/or the second opening 226 in the same manner.

Referring to the FIGS. 5 and 7 examples, each of the mount insert 260 for the first mount 216 and the mount insert 260 for the second mount 218 each include two mount inserts 260 positioned distant from one another (i.e., a total of four of the mount inserts 260 for the pressure vessel 200). The fastener 310 for the first mount 216 and the fastener 310 for the second mount 218 each include two fasteners 310 (i.e., at total of four fasteners 310 for the pressure vessel 200) engaged with the two mount inserts 260, respectively.

As best seen in the example in FIG. 5, the two mount inserts 260 for the first mount 216 and the two mount inserts 260 for the second mount are positioned a laterally equal distance 284a from a centerline 286 of the first end cap 214 and the second end cap 220, respectively, as generally shown. In one example, the distance 284a is 25 millimeters (mm). In one example, a distance 284c between the axis 270 of the two mount inserts 260 is 65 millimeters (mm). In one example, a distance 284b between the centerline 286 and a center axis of the first opening 224 and the distance 284b between the centerline 286 and a center axis of the second opening 226 is 40.6 millimeters (mm). It is understood that the mount inserts 260, and the first opening 224 and the second opening 226 in the first end cap 214 and the second end cap 220, may be at different positions and distances relative to one another and the centerline 286 or the longitudinal axis 209 to suit the particular application and performance specifications as known by persons skilled in the art. It is understood that more than two, or less than two, mount inserts 260 for each of the first mount 216 and the second mount 218 may be used to suit the particular application and performance requirements as known by persons skilled in the art.

Referring to the FIGS. 1B and 7 example, the mounting bracket 296a, 296b includes a base 300, sidewalls 304 connected to the base 300, and a flange 308 connected to the sidewalls 304. In the example, the flange 308 defines an aperture 309 (two shown) for attachment of the mounting bracket 2967a, 296b to an object, for example a transportation vehicle as described above, by a fastener (not shown). In one example, the base 300 includes inwardly extending feet each having an aperture (not shown) aligned with the mounting holes 266 of the mount inserts 260. In the example, the fastener 310 passes through the aperture 309 and the fastener 310 is secured in the mount insert 260 to secure the mounting bracket 296a, 296b to the first end cap 214 and the second end cap 220, respectively. In one example, the mounting bracket 296a, 296b is made from stainless steel. Other materials, for example steel or non-ferrous metals (e.g., aluminum), composites, and other materials suitable for the application and performance specifications may be used as known by persons skilled in the art. It is understood that the first mount 216 and the second mount 218 (not shown) as described above for the pressure vessel 200 may be used in the pressure vessel 200b at the first ends 215, 221 of the first end cap 214a and the second end cap 220a, respectively.

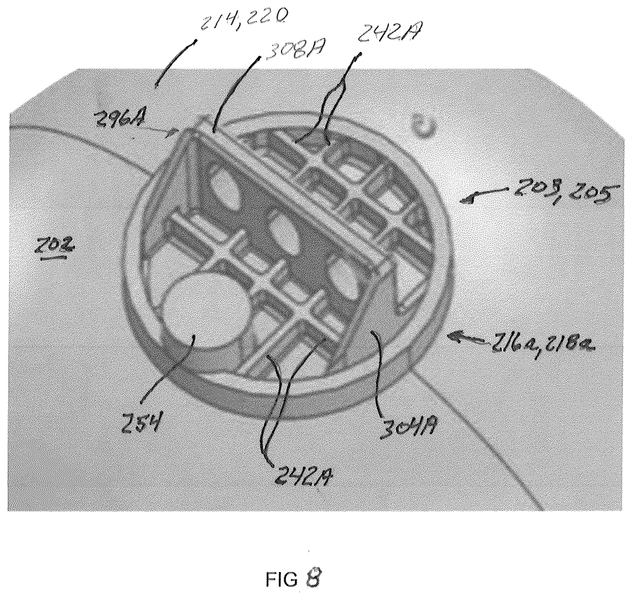

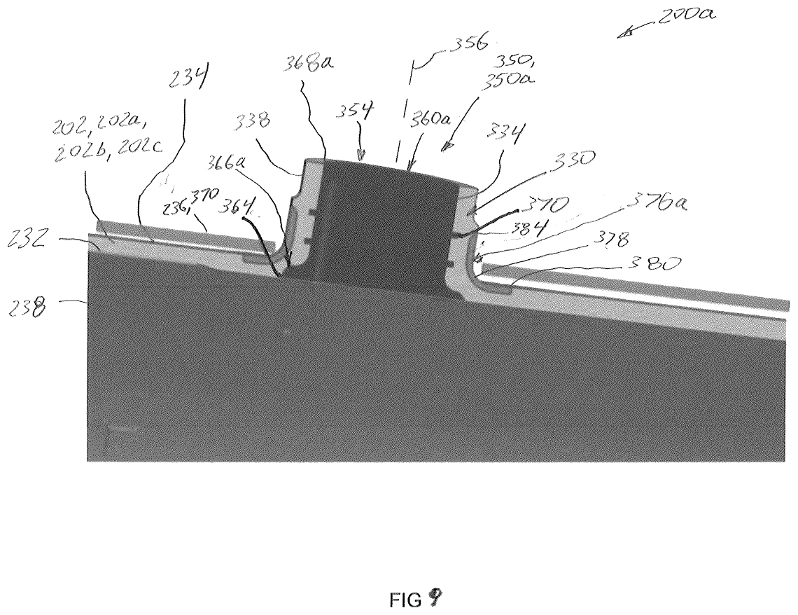

Referring to FIG. 8, an alternate example of the first mount 216a and the second mount 218a is shown. In the example, the mount insert 260, the fastener 310, and the mounting bracket 296a, 296b as a separate part of the first mount 216 and the second mount 218 are not used. In the FIG. 8 example, the mounting bracket 296c is integrally molded into the wall 202b at the first end 215 of the first end cap 214 and at the first end 221 of the second end cap 220, respectively. In the example, the mounting bracket 296c includes sidewalls 304a and a flange 308a as generally shown. It is understood that the FIG. 8 alternate first mount 216a and the second mount 218a may be used for the pressure vessel 200b in the FIGS. 2A, 2B example. It is understood that the mounting bracket 296c may take other forms, configurations, sizes and shapes to suit the particular application and performance requirements as known by persons skilled in the art.

In one example of the pressure vessel 200 shown in FIG. 3, the pressure vessel 200 includes a dividing wall 314 (shown in phantom line) connected to the wall 202a of the upper shell 210 or the lower shell 212, or the wall 202b of the first end cap 214, or the wall 202c of the second end cap 220, configured to separate the inner volume 238 into a first inner volume 238a and a second inner volume 238b. In one example, the pressurized air in the first inner volume 238a is sealingly separated from the pressurized air in the second inner volume 238b. This allows for the pressure vessel 200 to include separate air volumes to, for example, provide pressurized air to two separate systems of the vehicle. In one example, the second inner volume 238b may be larger in storage capacity than the first inner volume 238a. In another example, the first inner volume 238a may contain the pressurized air at a higher or lower air pressure than the second inner volume 238b to suit a particular application.

In one example, the dividing wall 314 is connected to the inner surface 232a of the central shell 206 (or the inner surface 232a of the upper shell 210 or the lower shell 212), the inner surface 232b of the first end cap 214, and/or the inner surface 232c of the second end cap 220. The dividing wall 314 can take forms or configurations which are configured to separate the first inner volume 238a from the second inner volume 238b, and be of sufficient strength to withstand the pressurized air without leaking, as described above. In one example, the dividing wall 314 can be constructed in the form of a center column 130 that defines a first inner volume 132 as best seen in FIG. 17. In the example, the outer surface of the center column and the wall 102 define a second inner volume 134. In the example, internal ribs 136 may be used between the center column 130 and the wall 102 as generally shown. In one example, the dividing wall 314 can be formed, constructed and/or configured as a separation closure head as shown and described in US Patent Application Publication No. 2023/0235853 assigned to WAL Low Carbon Technology Co., Ltd. And WAL Fuel Systems USA Inc., the entire contents of which is incorporated herein by reference. In one example, the dividing wall 314 may be integrally formed along with the respective wall 202 or may be separately formed and securely fixed to the wall 202 to define the separate inner volumes as described.

It is understood that more than one dividing wall 314 may be used. In one example, two dividing walls may be used to form the first inner volume 238a, the second inner volume 238b, and a third inner volume (not shown). It is understood that more than two dividing walls may be used to form additional inner volumes to suit the particular application and performance requirements as known by persons skilled in the art. In the examples, for each separate inner volume that is defined, the pressure vessel 200 may include the first opening 224 and the second opening 226, for example in the form of the air port 227, such that each inner volume includes an air port to allow pressurized air to enter and exit the respective inner volume. Alternate constructions, configurations and components for dividing wall 314 may be used to suit the particular application and performance requirements as known by persons skilled in the art.

Referring to the examples of the invention shown in FIGS. 9-11B, an alternate example of the pressure vessel 200a includes an insert 350 engaged with the wall 202 and defines an opening 354 in communication with the inner volume 238 of the pressure vessel 200. In one example, the opening 354 is one of the first opening 224 or the second opening 226 described above for the pressure vessel 200.

In one example, the examples of the insert 350 described below are useful with the pressure vessel 200, 200b described above and shown in FIGS. 1A-8. In one example, the insert 350, including the opening 354 defined by the insert, may be used to form one or more of the first opening 224, the second opening 226 (e.g., the air port 227), and/or the drain port 228 described above for the pressure vessel 200.

In the alternate example of the pressure vessel 200a discussed below and shown in FIGS. 9-11B, like reference numbers refer to the same, or substantially the same, components as described above for the pressure vessel 200 unless specifically noted.

In an alternate example of the pressure vessel 200 and 200b, a pressure vessel 200a includes a central shell 206 having a first end 203 and a second end 205 spaced along a longitudinal axis 209. In an alternate example, the pressure vessel 200a may be configured the same or similarly to the pressure vessel 200b shown in FIGS. 2A, 2B (e.g., first end cap 214a and second end cap 220a). As described above, in one example the central shell 206 may include the upper shell 210 and the lower shell 212. The pressure vessel 200a includes a first end cap 214 having a first end 215 and a distal end 217 spaced along the longitudinal axis 209, the distal end 217 of the first end cap 214 is connected to the first end 207a of the central shell 206 at a first end cap seam 230. A second end cap 220 having a first end 221 and a distal end 222 is spaced along the longitudinal axis 209, the distal end 222 of the second end cap 220 is connected to the second end 207b of the central shell 206 at a second end cap seam 231. The central shell 206, the first end cap 214, and the second end cap 220 include a wall 202 (e.g., 202a, 202b, and/or 202c, respectively) formed from a polymeric material and define an inner volume 238. An insert 350 is engaged with the wall 202 and defining an opening 354 having an axis 356 in communication with the inner volume 238.

Referring generally to the examples shown in FIGS. 9-11B, in one example of the pressure vessel 200a, the wall 202 includes an inner surface 232 (e.g., 232a, 232b, and/or 232c), an outer surface 234 (e.g., 234a, 234b, and/or 234c), and an annular flange 330 formed from the polymeric material and extending axially outward from the outer surface 234 of the wall 202 parallel to the axis 356. The annular flange 330 having an interior surface 334 and an exterior surface 338 spaced radially outward from the interior surface 334 relative to the axis 356. In one example, the annular flange 330 is integrally formed with the wall 202, for example in an injection molding process. In an alternate example, the annular flange 330 may be separately formed from the wall 202 and fixedly connected to the wall 202 following the manufacture of the wall 202. Again, it is understood that the FIGS. 9-11B examples are equally useful for the pressure vessel 200b shown in FIGS. 2A, 2B.

Referring to the example shown in FIG. 9, the insert 350 includes a first insert 360a engaged with the interior surface 334 of the annular flange 330. The first insert 360a defining the opening 354 having the axis 356 in communication with the inner volume 238. A second insert 376a is spaced radially outward from the first insert 360a and is engaged with the annular flange 330 as generally shown.

In one example, the first insert 360a includes a first end 364 positioned adjacent to the inner surface 232 of the wall 202 as generally shown. A second end 368 is axially spaced from the first end parallel to the axis 356 of the opening 354. In the example shown in FIG. 9, the first insert 360a includes a base 366a positioned at the first end 364 of the first insert 360a. In one example as shown, the base 366a is radially larger at the first end 364 than the second end 368 of the first insert 360a relative to the axis 356 of the opening 354. The base 366a may take other forms, configurations, shapes, sizes and positions relative to the wall 202, to suit the particular application and performance requirements as known by persons skilled in the art.

Still referring to the FIG. 9 example, the first insert 360a includes a radial flange 370 (four shown) axially positioned between the base 366a and the second end 368, the radial flange extending radially outward into the annular flange 330 and is configured to prevent rotation of the first insert 360a about the axis 356 and axial movement parallel to the axis 356 relative to the annular flange 330. The radial flange 370 may take other forms, configurations, shapes, sizes, numbers, and positions relative to the wall 202, to suit the particular application and performance requirements as known by persons skilled in the art. In one example not shown, the first insert 360a may include internal threads, or coupling structures (e.g., air tight quick connect or permanent couplings) to allow the pressure vessel 200a to sealingly connect to hoses, conduits, or other structures configured to allow the pressurized air to enter or exit the inner volume 238 through the insert 350.

In one example, the first insert 360a is integrally molded (e.g., overmolded) in the polymeric material of the wall 202 and/or the annular flange 330. In an alternate example, the first insert 360a may be fixedly connected to the interior surface 334 of the annular flange 330 following the manufacture of the wall 202 and the annular flange 330 by devices or methods as known by persons skilled in the art.

Still referring to the FIG. 9 example, the second insert 376a includes a first end 380 positioned on, in, or adjacent to the wall 202 and a second end 384 positioned on, in or adjacent to the annular flange 330. In the example shown in FIG. 9, the second insert 376a is a reinforcement ring 378 positioned on the outer surface 234 of the wall 202 and extending to the exterior surface 338 of the annular flange 330 as generally shown. In the example shown in FIG. 9, the reinforcement ring includes the first end 380 in the outer surface 234 of the wall 202, and the second end 384 is positioned in the exterior surface 338 of the annular flange 330 as generally shown. In one example, the reinforcement ring 378 is a continuous annular ring configured to surround the annular flange 330 as generally shown to reinforce the annular flange 330 and the wall 202 adjacent to the annular flange 330.

In one example, the second insert 376a is integrally molded (e.g., overmolded) in the polymeric material of the wall 202 and/or the annular flange 330. In an alternate example, the second insert 376 may be fixedly connected to the outer surface 234 of the wall and the exterior surface 338 of the annular flange 330 following the manufacture of the wall 202 and the annular flange 330 by devices or methods as known by persons skilled in the art. In one example, the first insert 360a and the second insert 376a (e.g., the reinforcement ring 378) are integrally molded in the polymeric material of the wall 202 and the annular flange 330. In an alternate example, either the first insert 360a or the second insert 376a may be integrally molded in the wall 202 and/or the annular flange 330. In an alternate example, neither the first insert 360a or the second insert 376a are integrally molded in the wall 202 or the annular flange 330 and are fixedly connected to the wall 202 or the annular flange 330 following the manufacture of the wall 202 and the annular flange 330 as described above.

Still referring to the FIG. 9 example, the positions and configurations of the first insert 360a and the second insert 376a result in a portion of the polymeric material molded between the first insert 360a and the second insert 376a. This reduces or eliminates deformation (i.e., expansion or contraction) of the polymeric material in the annular flange 330 and the adjacent portions of the wall 202 thereby increasing the strength and durability of the annular flange 330 (e.g., the first opening 224, the second opening 226, the air port 227, and/or the drain port 228) and the wall 202 adjacent the annular flange 330.

In one example, the first insert 360a and the second insert 376a are formed from a metallic material (e.g., ferrous or non-ferrous metals). Other materials may be used, for example, composites (e.g., carbon fiber or other fiber reinforced resins), and other materials as known by persons skilled in the art.

It is understood that the insert 350a, and the first insert 360a and the second insert 376a may take other forms, configurations, sizes, shapes, materials, and positions relative to each other and the wall 202 and the annular flange 330, to suit the particular application and performance requirements as known by persons skilled in the art.

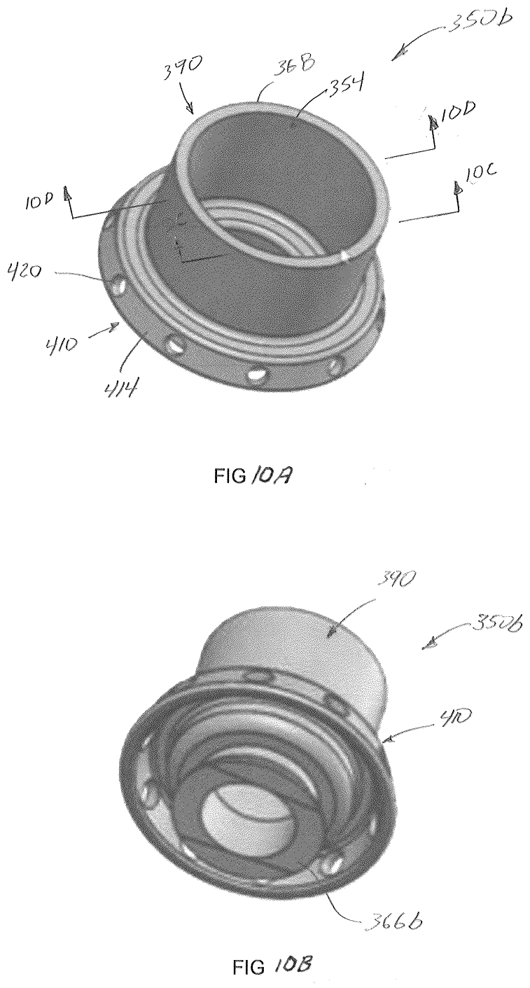

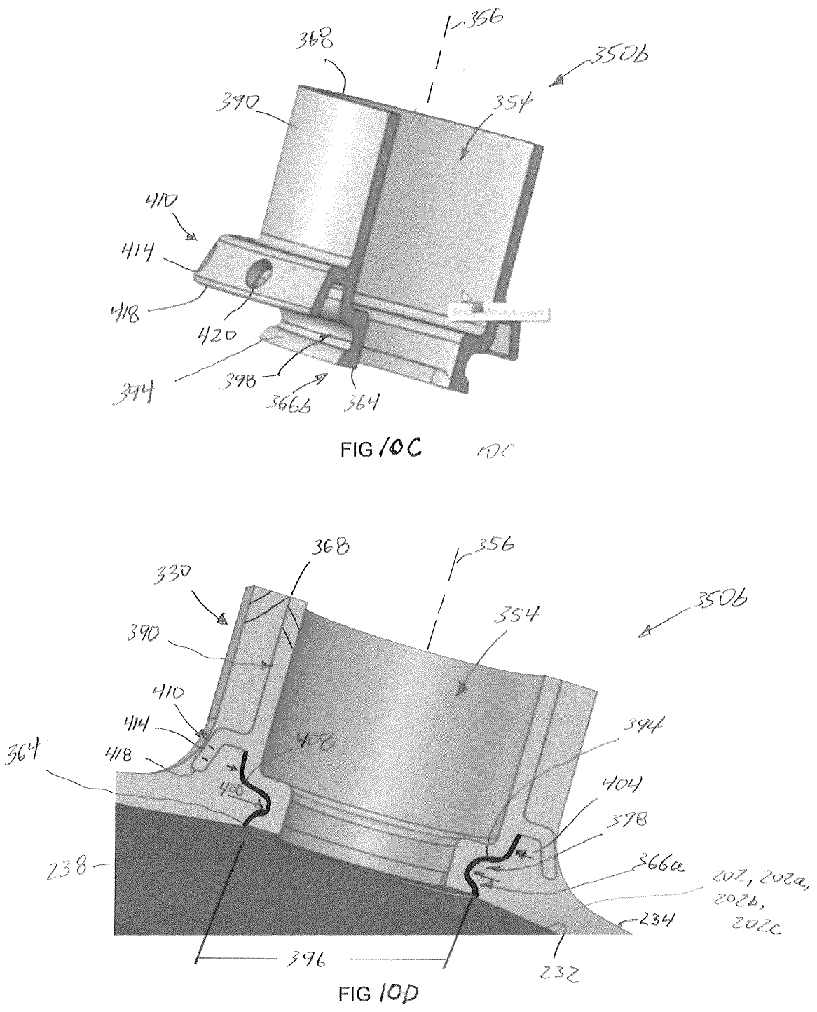

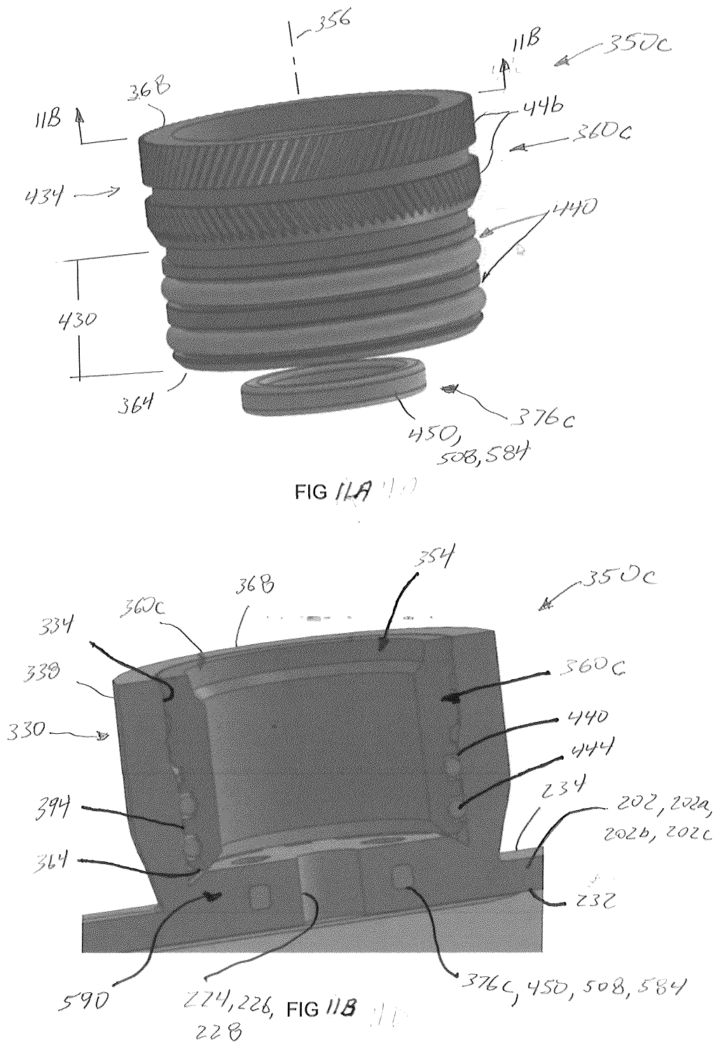

Referring to FIGS. 10A-10D, an alternate example of the insert 350 for use in the pressure vessel 200, 200a is shown. In the example as best seen in FIG. 10D, the insert 350b includes the first end 364 positioned adjacent to the inner surface 232 of the wall 202, and the second end 368 axially spaced from the first end 364 relative to the axis 356. The insert 350b includes the base 366b positioned at the first end 364, and includes an upper portion 390 connected to the base 366b extending to the second end 368. In the example shown, the insert 350b includes a collar 410 extending radially outward from the upper portion 390 relative to the axis 356.

As best seen in FIGS. 10C and 10D, the base 366b includes an outer surface 394 having a first diameter 396 at the first end 364. In the example, a groove 398 is positioned axially above the first diameter 396 of the first end 364, the groove having a second diameter 400 different than the first diameter 396. The base 366b further includes a third diameter 404 positioned axially above the groove 398. In one example as best seen in FIG. 10D, the second diameter 400 is less than the first diameter 396 and the third diameter 404. In one example, the third diameter 404 is larger than the first diameter 396 and the second diameter 400. It is understood that the first diameter 396, the second diameter 400 and the third diameter 404 may take alternate values, both larger or smaller, relative to the other diameters to suit the particular application or performance requirements as known by persons skilled in the art.

As best seen in FIG. 10D example, the first diameter 396, the second diameter 400 and the third diameter 404 at the outer surface 394 form a joint 408 (shown in darker thicker line in FIG. 10D) at the outer surface 394, wherein the joint 408 is configured to prevent, or reduce, the pressurized air from passing from the inner volume 238 through the joint 408. This is due in part to the configuration of the base 366b (i.e., the first diameter 396, the second diameter 400 formed by the groove 398, the third diameter 404 and the collar 410 configuration described below.

Still referring to the FIGS. 10A-10D example, the collar 410 includes a lip 414 extending angularly downward and away from the second end 368 and having a distal end 418 as generally shown. As best seen in FIGS. 10A and 10C, the lip 414 includes at least one aperture 420 (several shown) through the lip 414. The at least one aperture 420 allows the polymeric material to flow through the at least one aperture 420 during the injection molding process when the insert 350b is integrally molded into the annular flange 330 as described below.

In one example as best seen in FIG. 10D, the insert 350b is integrally molded in the polymeric material of the wall 202 and the annular flange 330 as generally shown. In the FIG. 10D example, a portion of the annular flange 330 is positioned (i.e., sandwiched) between the lip 414 and the base 366b. As similarly and generally described above for the insert 350a, having a portion of the polymeric material molded between the lip 414 and the base 366 reduces or eliminates deformation (i.e., expansion or contraction) of the polymeric material in the annular flange 330 and the adjacent portions of the wall 202 thereby increasing the strength and durability of the annular flange (e.g., the first opening 224, the second opening 226, the air port 227, and/or the drain port 228) and the wall 202 adjacent the annular flange 330.

In one example, the insert 350b may be made from a metallic material (e.g., ferrous or non-ferrous metals), composites (e.g., carbon fiber or other fiber reinforced resin) and other materials known by persons skilled in the art.

It is understood that the insert 350b may take other forms, configurations, shapes, sizes, materials, features and positions relative to the annular flange 330 and the wall 202, to suit the particular application and performance requirements as understood by persons skilled in the art.

Referring to FIGS. 11A and 11B, an alternate example of the insert 350 is shown. In the example, insert 350c is useful in the pressure vessel 200, 200a as described above. In the example as best seen in FIG. 11B, the insert 350c includes a first insert 360c engaged with the interior surface 334 of the annular flange 330, the first insert 360c defining the opening 354 having the axis 356 and is in communication with the inner volume 238. A second insert 376c is axially spaced from the first insert 360c and is engaged with the wall 202 as generally shown.

As best seen in the FIGS. 11A and 11B example, the first insert 360c includes the first end 364 positioned adjacent to the wall 202, a second end 368 axially spaced from the first end 364 relative to the axis 356, an upper portion 434 including the second end 368, and a lower portion 430 connected to the upper portion and including the first end 364. In the example shown, the lower portion 430 defines an annular groove 440 (two shown).

In one example, a seal 444 (two shown, one for each annular groove 440) is positioned in the annular groove 440 and is configured to prevent the pressurized air from passing between an outer surface 394 of the lower portion 430 and the interior surface 334 of the annular flange 330. The seal 444 may be configured as an O-ring type seal and be made from polymeric or elastomeric materials suitable for creating an airtight seal between two surfaces. Other forms, configurations and materials for the seal 444 may be used to suit the particular application as known by persons skilled in the art. In one example of pressure vessel 200a, the seal 444 is not used.

As best seen in the FIG. 11A example, the upper portion 434 includes formations 446 in the outer surface 394 configured to engage the interior surface 334 of the annular flange 330 to prevent rotation of the first insert 360c about the axis 356 and axial movement parallel to axis 356 relative to the annular flange 330. In one example, the formations 447 include knurling, or grooves. Other types or configurations for the formations 446 may be used, for example, channels, radially extending flanges or other structures, to suit the particular application and performance requirements as known by persons skilled in the art.

Still referring to the FIGS. 11A and 11B example, the second insert 376c is a reinforcement ring 450 integrally molded in the polymeric material of the wall 202 as generally shown. In one example, the reinforcement ring is a continuous and uninterrupted circular ring.

In one example, the first insert 360c is inserted and fixedly connected to the annular flange 330 following the manufacture of the wall 202 and the annular flange 330. In one example, either or both of the annular flange 330 or the first insert 360c are heated and the outer surface 394 of the first insert 360 engages and fixedly connects the first insert 360 to the interior surface 334 of the annular flange 330. In one example, portions of the polymeric material of the interior surface 394 of the annular flange lockingly engage with the formations 446 preventing rotational or axial movement of the first insert 360c relative to the annular flange 330. It is understood that connection of the first insert 360c to the annular flange 330 may be by other devices or methods, for example, integrally molding the first insert 360c into the wall 202 and the annular flange 330.

In one example, the first insert 360c and the second insert 374c (e.g., the reinforcement ring 450) are made from a metallic material or other materials described above for the inserts 350a, 350b. It is understood that alternate forms, configurates, shapes, sizes, materials, and alternate positions relative each other and/or to the annular flange 330, may be used to suit the particular application and performance specifications as known by persons skilled in the field.

As generally described above and illustrated, each of the inserts 350 (e.g., 350a, 350b, and/or 350c) may be used for the pressure vessel 200, 200b or the pressure vessel 200a. As further described, the insert 350 may be used to form the first opening 224 and/or the second opening 226. In the examples described above, in use to define the first opening 224 and/or the second opening 226, the insert 350 may serve as one or more air ports 227 configured to allow the pressurized air to enter or exit the inner volume 238. In an alternate example, the insert 350 may be used for the drain port 228. In one example, the first opening 224, the second opening 226, or the air port 227, are configured or useful to provide pressurized air to the automatic braking system (ABS) of the vehicle. As described above, the pressure vessel 200, 200a has alternate applications to provide the pressurized air or other fluids to other vehicle systems, and has applications other than in vehicles.

Referring to FIGS. 12A-16, examples of a mold cavity die 500 for forming an injection molded part and a examples of a method for inserting a reinforcement in an injection molded part 600 are shown. In one example, the injection molded part is the pressure vessel 200, 200a, 200b.

Referring to FIGS. 12A-12D, an example of a mold cavity die 500 is shown. In one example the mold cavity die 500 is useful in forming an injection molded part. In one example application, the mold cavity die 500 is used to form a pressure vessel 200, 200a and/or 200b as described above. In one example use, the mold cavity die 500 is used to form the first opening 224, the second opening 226, the air port 227, or the drain port 228 as described and illustrated above. In one example, the mold die cavity 500 and the method 600 are used to form the pressure vessel including the insert 350C shown in FIGS. 11A and 11B. The mold cavity die 500 and the method 600 have other applications, including use in other molding processes, as known by persons skilled in the art.

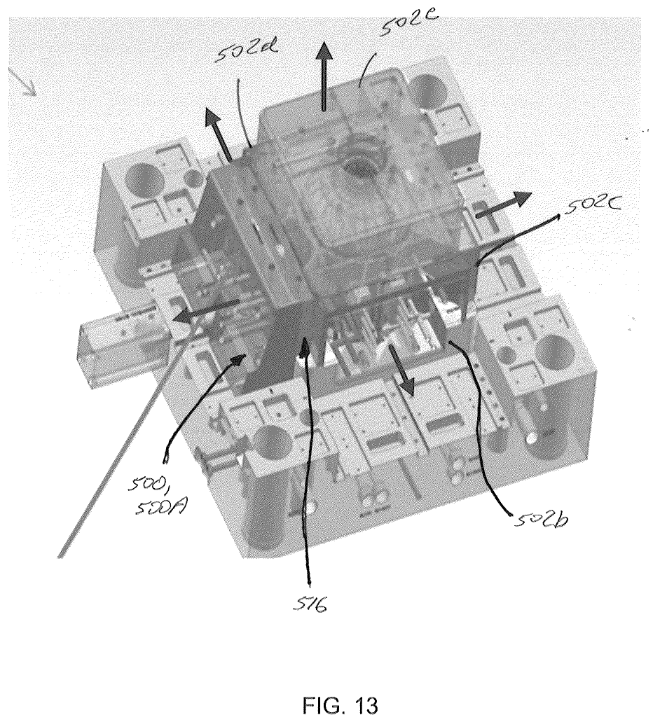

As best seen in FIGS. 12C, 12D, and 13 example, the mold cavity die 500 may be used with additional mold cavity dies, or mold cavity die portions. In one example, the mold cavity die 500 shown in FIGS. 12A-12C may be a first mold cavity die 502a. Depending on the configuration of the injection molded part, for example a pressure vessel 200, 200a or 200b, as best seen in the FIG. 13 example, the mold cavity die 500 may be a first mold cavity die 500a, and may be used in combination with a second mold cavity die 502b, a third mold cavity die 502c, a fourth mold cavity die 502d, and a fifth mold cavity die 502e, as generally shown.

In one example, the mold cavity die 500 includes the first mold cavity die 500, 502a having the frame 510, the cavity die 516 and the insert die 530. A second mold cavity die 502b is engaged with the first mold cavity die 502a when the frame 510 of the first mold cavity die 502a is positioned in the second position as described above. In the example, the mold cavity die 500 further includes the core mold die (not shown), wherein the first mold cavity die 502a, the second mold cavity die 502b are configured to receive the core mold die. In the example, the first mold cavity die 502a, the second mold cavity die 502b, and the core mold die forming the mold cavity 504 for the injection molded part 506.

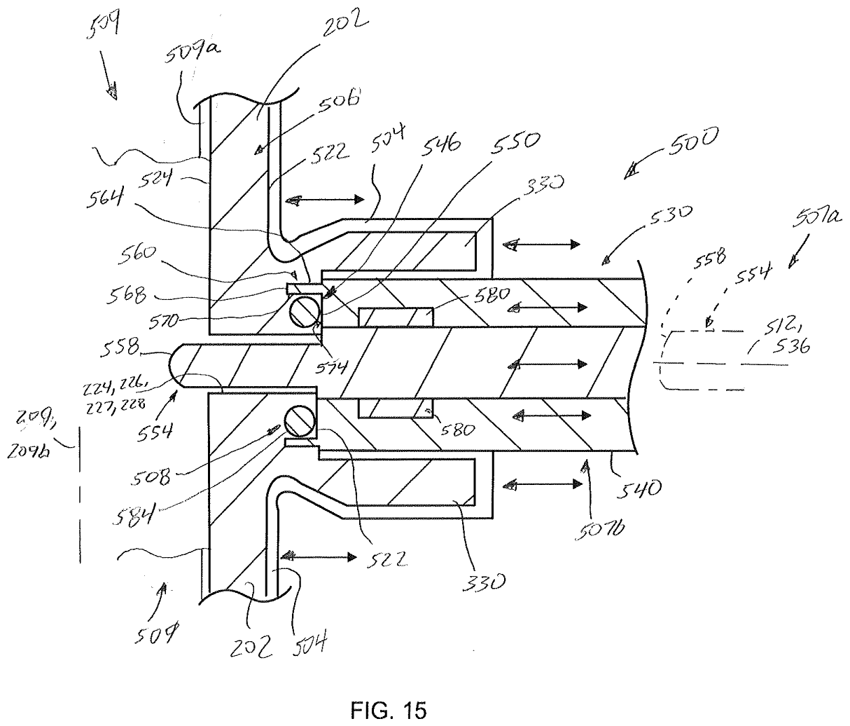

One or more of the mold cavity dies 502a-e may be included in a slide allowing the mold cavity die to move (e.g., axially as generally shown by the outwardly pointing arrows in FIG. 13) relative to the other mold cavity dies, and/or a core die (not shown). In one example, the mold cavity die 500 includes a first position 507a (partially shown in FIG. 15) wherein the mold cavity die 500 is positioned away from the core die (i.e., not in an injection molding position) and a second position 507b (shown in FIG. 13 and in solid line in FIG. 15), wherein the mold cavity die 500 is positioned to form a mold cavity 504 for receipt of molten material in the injection molding process as discussed further below.

The mold cavity dies (i.e., the mold cavity die 500, any other mold cavity dies, and the core die) are configured to form the mold cavity 504 to form an injection molded part 506 by injecting into the mold cavity 504 the molten material, for example, plastic, to form the desired part, for example the pressure vessel 200.

The mold cavity die 500 is used in an injection molding machine (not shown) as known by persons skilled in the art and is not further discussed herein. In one example discussed further below, the mold cavity die 500 is useful in inserting and positioning a reinforcement 508 in the mold cavity 504 which is then surrounded, or partially surrounded, by the molten material through the injection molding process to form injection molded part 506.

Referring to the FIGS. 12A-12D example, the mold cavity die 500 includes a frame 510 which is movable along a slide axis 512 between the first position 507a and a second position 507b. In one example, the frame 510 is connected to an actuator (not shown) which is configured to move the frame 510 between the first position 507a and the second position 507b. In one example, the movement is axial movement parallel to the slide axis 512. It is understood that the movement may be in a direction or along a path of travel that is not axial (i.e., not linear). Although shown in a general “C” or “U” shaped form, it is understood that the frame 510 can take other forms, configurations, shapes, sizes and components to suit the particular application or performance requirements. In one example (not shown) the frame does not move between the first position and the second position, and/or relative to any other mold cavity dies or the core die.

The mold cavity die 500 includes a cavity die 516 is connected to the frame 510 and is moveable with the frame 510. In the example shown, the cavity die 516 includes an inner surface 520 that is configured to form an exterior surface 522 (e.g., the exterior surface of the central shell 206, the upper shell 210, the lower shell 212, the first end cap 214, or the second end cap 220), or a portion of the exterior surface 522, of the injection molded part 506. In one example, the cavity die 516 is made from steel (e.g., tool steel or tool grade steel) and may include surface treatments, such as surface hardening. Other materials, for example aluminum or other non-ferrous metals, may be used to suit the particular application and performance requirements as known by persons skilled in the art.

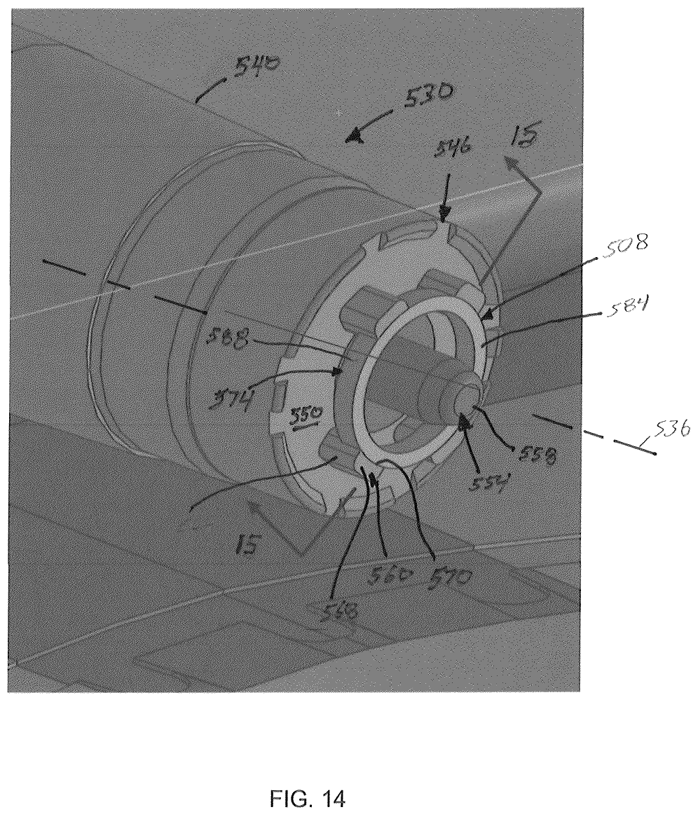

In the example as best seen in FIGS. 12A and 14, the cavity die 516 includes an insert die 530 extending inward (e.g., toward the longitudinal axis 109 of the pressure vessel), and parallel to an insert die axis 536 as generally shown. As best seen in the FIG. 14 example, the insert die 530 includes a base 540 having a distal end 546 including an insert surface 550 as generally shown. In the example, the base 540 is cylindrical-shaped or conically shaped that is tapered in diameter toward the distal end 546 to take into account a draw angle that may be needed to remove the cavity die 516 from the completed injection molded part 506.

As best seen in the FIGS. 14 and 15 example, the insert die 530 includes a pin 554 connected to the base 540 of the insert die 530. In the example, the pin is positioned along, or parallel to, the insert die axis 526 and extending inward (e.g., toward the longitudinal axis 109) from the insert surface 550 to a distal end 558 positioned in the inner volume 238 of the injection molded part (e.g., the pressure vessel 200, 200a, or 200b) when the frame 510 and the connected die insert 520 are positioned in the second position 207b as shown in FIG. 15. In one example, the pin 554 is configured to form the through opening (e.g., the first opening 224, the second opening 226, the air port 227, or the drain port 228) in the wall 202 in communication with the inner volume 238 when the molten material is injected into the mold cavity 504 and is cured or hardened.

In the example shown, the pin 554 is fixedly connected to the base 540 of the insert die 530. In an alternate example (not shown) the pin 554 may move axially relative to the base parallel to the insert die axis 536. In the example, the pin 554 is connected to an actuator (not shown) to selectively move the pin 554 relative to the base 540. Although one insert die 530 is illustrated, it is understood that more than one insert die 530 may be used in the mold cavity die 500. In one example (not shown), the mold cavity die 500 does not include the insert die.

In one example of the mold cavity die 500 as best seen in FIGS. 15 and 13, in the example where the injection molded part is the pressure vessel 200 having the wall 202 defining a through opening (224, 226, 227 or 228) in communication with the inner volume 238, and an annular flange 330 extending parallel to the axis 356 of the annular flange 330, the insert die includes the pin 554 connected to the base of 540 of the insert die. As described above and as best seen in FIG. 15, the pin extending inward from the insert surface 550 to the distal end 558 that is positioned in the inner volume 238 of the pressure vessel 200, 200a, 200b when the frame 510 is positioned in the second position (e.g., FIGS. 13 and 15). As described, the pin 554 is configured to form the through opening in the wall 202 in communication with the inner volume 238.

In one example, the pin 554 is made from the same material as the base 540 of the insert die 530, It is understood that the pin 554 may take other forms, configurations, shapes, sizes, numbers of pins, materials, and locations or orientations relative to the base 540, the insert surface 550, and/or the insert die 530 to suit the particular application and performance requirements as understood by persons skilled in the art.

In the example shown in FIG. 14, a retainer 560 is connected to the base 540 and is configured to removably secure the reinforcement 508 in a predetermined position relative to the insert die 560.

In one example, the predetermined position relative to the insert die positions the reinforcement 508 in abutting contact with at least a portion of the insert surface 550 and in predetermined X, Y and Z coordinates relative to the insert die 560. In one example, the predetermined position relative to the insert die 560 may be to a surface, for example a design reference surface, or surfaces, of the cavity die 560, the frame 510, or other surface of the mold cavity die 500. In one example, the design reference surface is a surface that is accurately and precisely manufactured to a design dimension or design X, Y and Z coordinates (e.g., manufactured to close or tight dimensional tolerances). In an alternate example the predetermined position relative to the insert die does not place the reinforcement 508 in contact with the insert surface 550. In one example, the retainer 560 may position the reinforcement 508 axially spaced and/or at an angle relative to the insert surface 550.

In one example of the insert die 530 and the retainer 560, when the frame 510 and connected cavity die 516 are positioned in the second position 507b (e.g., FIGS. 13 and 15), the insert die 530 is configured to position the reinforcement 508 in a predetermine position in the mold cavity 504. In one example, for example wherein the reinforcement 508 is a reinforcement ring 584 discussed further below, the reinforcement 508 is positioned in the mold cavity 504 and is substantially surrounded on injection of the molten material (e.g, molten polymer) into the mold cavity 504 (e.g., as shown in FIG. 11B). In one example, the predetermined position in the mold cavity 504 is a known position relative to a surface (e.g., inner surface 520 of the cavity die 516) and/or a known or reference point or surface, and/or design dimension in X, Y and Z coordinates, as described above for the predetermined position relative to the insert die 530. It is understood that the predetermined positions relative to the inset die 530 and/or the mold cavity 504 may be different than as described to suit the particular application and performance requirements as known by persons skilled in the field.

As best seen in FIG. 15, in one example, the reinforcement 508 is a reinforcement ring 584 having an exterior surface 588. In the example, the reinforcement ring 584 is circular shaped and is hollow in the center as generally shown. In one example as best seen in FIGS. 11A and 11B, the reinforcement ring 584 is sized to have a diameter larger than the first opening 224, the second opening 226 (e.g., the through opening in the wall 202), and/or the drain port 228. In one application, the annular flange and the through opening in the wall 202 comprise a drain port 228 of the pressure vessel 200. In the FIG. 11B example, the reinforcement ring 584 is positioned at or near a base of the annular flange 330 (e.g., of a drain port 228) and is configured to reinforce the annular flange 330 and/or the local area of the wall 202, to prevent or reduce the likelihood of cracking and/or to reduce stress in the material caused from external and/or internal forces on the pressure vessel 200.

In one example, the reinforcement ring is made from a ferrous metal. It is understood that the reinforcement ring 586 may take other configurations, shapes, sizes, and be made from different materials (e.g., non-ferrous metals, composites, polymers etc.) to suit the particular application or performance requirements as known by persons skilled in the art. It is also understood that the reinforcement 508 may take other configurations, shapes, sizes, and be made from different materials (e.g., non-ferrous metals, composites, polymers etc.) other than the reinforcement ring 584 to suit the particular application as known by persons skilled in the art.

Referring to FIGS. 14 and 15, an example of the retainer 560 is shown. In the example, the retainer 560 includes a post 564 (four shown) extending axially inward from the insert surface 550. In the example, the post 564 includes an outer end 568 positioned toward the injection molded part 506 and an inner surface 570 configured to engage the reinforcement 508 and maintain the reinforcement 508 in the predetermined position relative to the insert die 530. In the example wherein the reinforcement 508 is the reinforcement ring 584, the inner surface 570 frictionally engages the exterior surface 588 of the reinforcement ring 584 (spaces shown between contact surfaces shown in FIG. 15 are for convenience of illustration only).

In one example, the post 564 includes four posts positioned angularly distant from one another about the insert die axis 536. In the example, the inner surface of each post 564 frictionally engaging the exterior surface of the reinforcement ring 584.

In one example, the post 564 may be made from the same material as the base 540 as described above. Other materials may be used for the post 564 as known by persons skilled in the art. It is further understood that the post 564 may take alternate configurations, shapes, sizes, numbers of posts, locations and/or orientations relative to each other post and the insert surface 550, and materials to suit the particular application (e.g., the form of the reinforcement 508) and performance requirements as known by person skilled in the art.

Referring to FIG. 15, an additional, or alternate, retainer 560 is shown. In the example, the retainer 560 includes a magnet 580 (two shown positioned diametrically apart) connected to the base 540 of the insert die 530 and is positioned in proximity to the insert surface 550 as generally shown. The magnet 580 is configured to apply a magnetic attractive force to bias the reinforcement 508 (e.g., the reinforcement ring 584) toward the insert surface 550 and maintain the reinforcement 508 in the predetermined position relative to the insert die 530. In one example, the magnet 580 is useful as a retainer 560, either to compliment the post 564, or as an alternate retainer to the post 564, where the reinforcement 508 is made from a ferrous metal.

In one example, the magnet 580 is a permanent magnet. In an alternate example, magnet 580 is an electromagnet that energizes and creates the magnetic attractive force when the magnet is supplied electricity from an electrical power source (not shown), in communication with the magnet 580. It is understood that the magnet 580 can take other forms, configurations, sizes, shapes, and locations or orientations relative to the base 540, the insert surface 550, or the insert die 530, to suit the particular application or performance requirements as known by persons skilled in the art.

It is understood that the mold cavity die 500 may take other forms, configurations, components, sizes, shapes, and be made from different materials, than those described and/or illustrated to suit the particular application and performance requirements as known by persons skilled in the art.

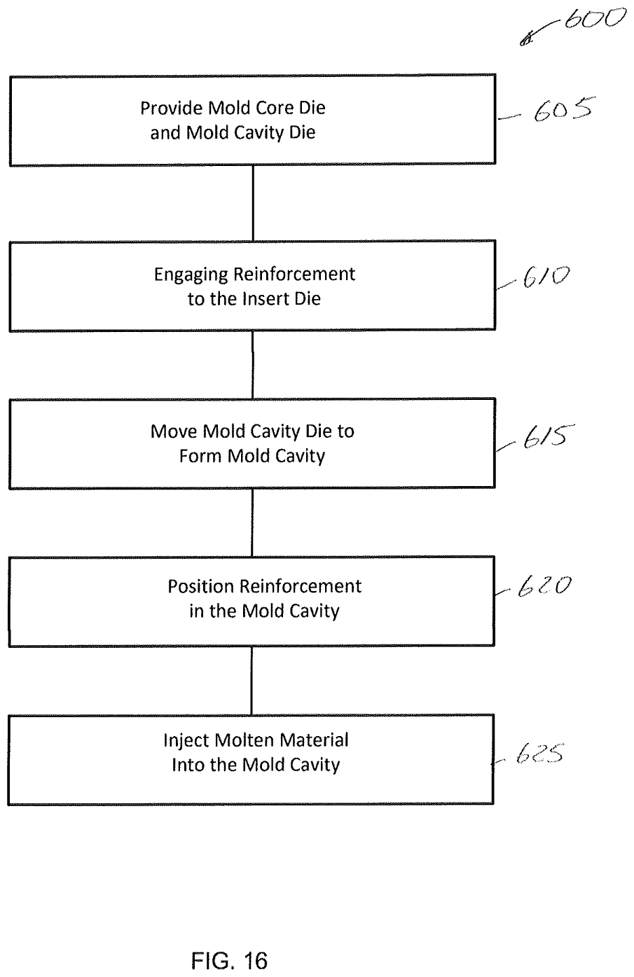

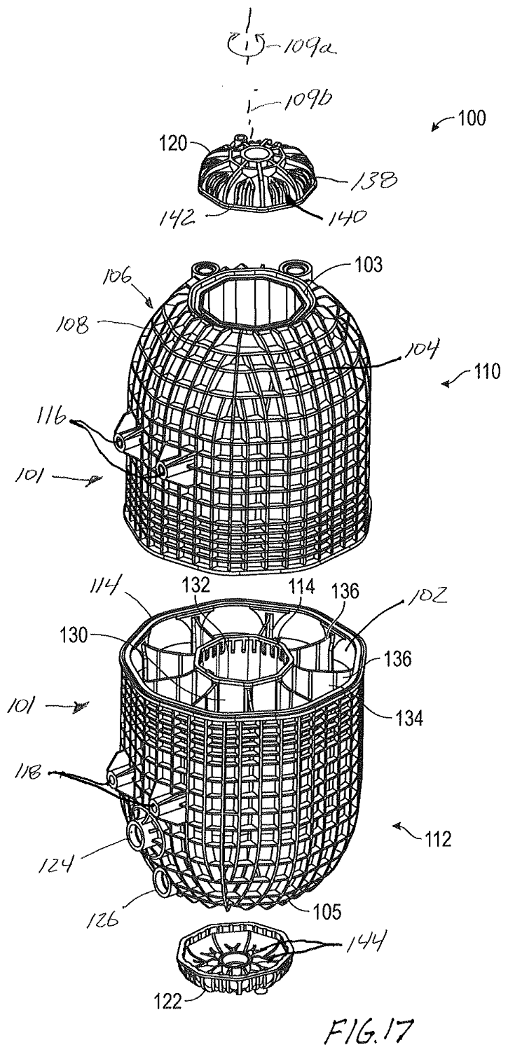

Referring to FIG. 16, an example of a method for inserting a reinforcement in an injection molded part 600 is shown. In the examples described like reference numerals are used for the same, or substantially the same, components as described above unless otherwise noted.

In the example method 600, the method includes the step 605 providing a mold core die 509, providing a mold cavity die 500 configured to receive the mold core 509 die and forming the mold cavity 504 defining the injection molded part 508. The mold cavity die 500 including the insert die 530 configured to position the reinforcement 508 in the predetermined position in the mold cavity 504 as described in the examples above. The method 600 includes the step 610 of engaging the reinforcement 508 with the insert die 530 to position the reinforcement 508 in a predetermined position relative to the insert die 530. In step 615 the method 600 includes moving the mold cavity die 500 relative to the mold core die 509 to form the mold cavity 504 and in step 620 positioning the reinforcement 508 in the predetermined position in the mold cavity 504. Step 625 includes injecting molten material into the mold cavity 504 to form the injection molded part 506. In one example step, the molten material substantially surrounds the reinforcement 508.

In one example of the method 600, the injection molded part 508 is the pressure vessel 200, 200a, 200b as described above. In one example of the method 600, the reinforcement 508 is the reinforcement ring 584 as described above.

In one example of the method 600, the insert die 530 includes the retainer 560 configured to removably secure the reinforcement 508 in the predetermined position relative to the insert die 530. In the example method 600, engaging the reinforcement 508 with the insert die 530 includes engaging the reinforcement 508 with the retainer 560. In one example of method 600, wherein the retainer 508 is the reinforcement ring 584 having the exterior surface 588 and the retainer 560 includes the post extending from the insert surface 550 of the insert die 530 and having the inner surface 550, the step 610 of engaging the reinforcement ring 584 with the retainer 560 includes frictionally engaging the exterior surface 584 of the reinforcement ring 584 with the inner surface of the post 564. In the example where four posts are used, the inner surface 570 of each post 564 frictionally engages the exterior surface 588 of the reinforcement ring 584.

In an alternate example of method 600, wherein the retainer 560 includes the magnet 580 connected to the insert die 520 proximate to the insert surface 550 of the insert die 530 and the reinforcement 508 is formed from a ferrous metal, the step 610 of engaging the reinforcement 508 with the retainer 560 includes generating the magnetic attractive force to maintain the reinforcement 508 in the predetermined position relative to the insert die 530.

In one example of method 600, the injection molded part 506 is the pressure vessel 200 configured to store and selectively provide pressurized air to an object, the pressure vessel 200 includes the wall 202, the annular flange 330 and the through opening (e.g., 224, 226, 227, 228) in communication with the inner volume 238 of the pressure vessel, the predetermined position in the mold cavity 504 of the reinforcement 508 is at a base 590 (see FIG. 11B) of the annular flange 330.

In one example, the method 600 includes a method for inserting the reinforcement ring 584 in the pressure vessel 200 formed by injection molding. The pressure vessel 200, 200a, 200b having the annular flange 330 defining the through opening (224, 226, 227, 228) in the wall 202 in communication with the inner volume 238 of the pressure vessel 200, 200a, 200b, the method includes providing the mold cavity die 500 having the inner surface 520 configured to form the exterior surface 522 of the pressure vessel 200, 200a, 200b, and the mold cavity die 500 including the insert die 530 configured to position the reinforcing ring in the predetermined position relative to the insert die. The example method includes providing the mold core die 509 having an outer surface 509a configured to form an interior surface 524 of the pressure vessel 200, wherein the inner surface 520 of the mold cavity die 500 and the outer surface 509a of the mold core die 509 forming the mold cavity 504 configured to receive molten material forming the wall 202 of the pressure vessel 200, 200a, 200b.

The example method further includes engaging the reinforcement ring 584 with the insert die 530, moving the mold cavity die 500 from the first position 507a in a first direction to the second position 5087b to receive the mold core die 509 to form the mold cavity 504, wherein the insert die 530 is configured to position the reinforcing ring 584 in the predetermined position in the mold cavity. The method includes injecting the molten material into the mold cavity 504 to form the wall 202 of the pressure vessel 200, wherein the molten material substantially surrounds the reinforcement ring 584. The method includes moving the mold cavity die 500 from the second position 507b in a second direction to the first position 507a to disengage the insert die 500 from the wall 202 of the pressure vessel 200, 200a, 200b, wherein the second direction is opposite the first direction.

It is understood that the method 600 may include additional steps, may remove steps, and/or may include the steps in an alternate order than as described and/or illustrated. The method 600 may further involve different or alternate components as described herein in one or more of the steps to suit the particular application and the performance requirements as understood by persons skilled in the art. It is further understood that the mold cavity die 500 and the method 600 are equally useful for the pressure vessels 200a and 200b as described and illustrated herein.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A pressure vessel comprising:
a first end cap comprising:
a first end and a distal end spaced in an axial direction;
a wall formed from polymeric material extending between the first end and the distal end of the first end cap; and
a first mount positioned at the first end of the first end cap configured to mount the pressure vessel to an object;
a second end cap spaced in the axial direction from the first end cap, the second end cap comprising:
a first end and a distal end spaced in the axial direction, the distal end of the second end cap is connected to the distal end of the first end cap at a central seam;
a wall formed from polymeric material extending between the first end and the distal end of the second end cap; and
a second mount positioned at the first end of the second end cap configured to mount the pressure vessel to the object, wherein the wall of the first end cap, and the second end cap, each includes an inner surface and an outer surface, the inner surface of the first end cap and the inner surface of the second end cap defining an inner volume of the pressure vessel; and
an external sheath substantially surrounding the outer surface of the first end cap, and the second end cap.

2. The pressure vessel of claim 1, wherein
the first mount comprises:
a mount insert engaged with the wall of the first end cap;
a fastener engaged with the mount insert of the first end cap; and
a first mounting bracket connected to the mount insert of the first end cap by the fastener; and
the second mount comprises:
a mount insert engaged with the wall of the second end cap;
a fastener engaged with the mount insert of the second end cap; and
a second mounting bracket connected to the mount insert of the second end cap by the fastener.

3. The pressure vessel of claim 2, wherein the first end cap and the second end cap each comprise reinforcing ribs integrally formed in the wall at the first ends, respectively, wherein the mount insert for the first mount and the mount insert for the second mount are integrally molded into the reinforcing ribs in the first end cap and the second end cap, respectively.

4. The pressure vessel of claim 3, wherein the reinforcing ribs in at least one of the first end cap or the second end cap define at least one first opening or a second opening in communication with the inner volume of the pressure vessel.

5. The pressure vessel of claim 3, wherein the reinforcing ribs comprise:
inner ribs connected to the inner surface of the wall of the first end cap and the second end cap; and
outer ribs connected to the outer surface of the wall of the first end cap and the second end cap, wherein the outer ribs are connected to the inner ribs.

6. The pressure vessel of claim 5, wherein the inner ribs and the outer ribs in the first end cap and the second end cap are oriented in cooperation to each define at least one of a first opening or a second opening in communication with the inner volume of the vessel.

7. The pressure vessel of claim 6 wherein the at least one first opening or the second opening comprise an air port configured to allow pressurized air to enter or exit the inner volume through the air port.

8. The pressure vessel of claim 5, wherein the inner ribs and the outer ribs are integrally molded with the wall.

9. The pressure vessel of claim 2, wherein the mount insert for the first mount and the mount insert for the second mount each comprise:
a body extending along an axis;
an inner surface defining a mounting hole along the axis; and
an outer surface having a radial flange configured to prevent rotation of the mount insert about the axis relative to the wall and prevent axial movement of the mount insert parallel to the axis relative to the wall.

10. The pressure vessel of claim 9, wherein the mount insert for the first mount and the mount insert for the second mount each comprise two mount inserts positioned distant from one another; and the fastener for the first mount and the fastener for the second mount each comprise two fasteners engaged with the two mount inserts, respectively.

11. The pressure vessel of claim 1, wherein the first mount and the second mount each comprise a mounting bracket integrally molded into the wall at the first end of the first end cap and the first end of the second end cap, respectively.

12. The pressure vessel of claim 1, comprising
a central shell having a first end and a second end spaced in the axial direction, the central shell including a wall having an inner surface and an outer surface formed from the polymeric material extending between the first end and the second end, wherein the first end of the central shell is connected to the distal end of the first end cap and the second end of the central shell is connected to the distal end of the second end cap, wherein the inner surface of the first end cap, the second end cap, and the central shell forming the inner volume of the pressure vessel.

13. The pressure vessel of claim 12, wherein the central shell comprises:
an upper shell having a first end and a second end spaced in the axial direction, the first end of the upper shell is connected to the distal end of the first end cap at a first end cap seam; and
a lower shell having a first end and a second end spaced in the axial direction, the first end of the lower shell is connected to the distal end of the second end cap at a second end cap seam and the second end of the lower shell is connected to the second end of the upper shell at the central seam.

14. The pressure vessel of claim 13, wherein the wall in at least one of the first end cap or the second end cap defines:
a first opening through the wall in communication with the inner volume; and
a second opening through the wall in communication with the inner volume.

15. The pressure vessel of claim 14, wherein the first opening and the second opening comprise an air port configured to allow pressurized air to enter or exit the inner volume through the air port.

16. The pressure vessel of claim 1, comprising:
a dividing wall connected to the inner surface of the wall of the first end cap or the second end cap configured to separate the inner volume into a first inner volume and a second inner volume, wherein pressurized air in the first inner volume is sealingly separated from pressurized air in the second inner volume.

17. The pressure vessel of claim 1, wherein the external sheath comprises:
reinforcing fibers embedded in a medium.

18. An air pressure vessel for use in a transportation vehicle comprising:
a first end cap comprising:
a first end and a distal end spaced in an axial direction;
a wall formed from polymeric material extending between the first end and the distal end of the first end cap;
reinforcing ribs integrally formed in the wall at the first end of the first end cap; and
a first mount positioned at the first end of the first end cap and connected to the reinforcing ribs of the first end cap, the first mount configured to mount the air pressure vessel to a transportation vehicle;
a second end cap spaced in the axial direction from the first end cap, the second end cap comprising:
a first end and a distal end spaced in the axial direction, the distal end of the second end cap is connected to the distal end of the first end cap at a central seam;
a wall formed from polymeric material extending between the first end and the distal end of the second end cap;
reinforcing ribs integrally formed in the wall at the first end of the second end cap; and
a second mount positioned at the first end and connected to the reinforcing ribs of the second end cap, the second mount configured to mount the air pressure vessel to the transportation vehicle, wherein the wall of the first end cap and the wall of the second end cap each includes an inner surface and an outer surface, the inner surface of the first end cap and the inner surface of second end cap defining an inner volume of the pressure vessel; and
an external sheath substantially surrounding the outer surface of the first end cap and the second end cap.

19. The pressure vessel of claim 18, wherein
the first mount comprises:
a mount insert integrally molded into the reinforcing ribs of the first end cap;
a fastener engaged with the mount insert of the first end cap; and
a first mounting bracket connected to the mount insert of the first end cap by the fastener; and
the second mount comprises:
a mount insert integrally molded into the reinforcing ribs of the second end cap;
a fastener engaged with the mount insert of the second end cap; and
a second mounting bracket connected to the mount insert of the second end cap by the fastener.

20. The pressure vessel of claim 18, wherein the reinforcing ribs of the first end cap and the second end cap each comprise:
inner ribs connected to the inner surface of the wall of the first end cap and the second end cap, respectively; and
outer ribs connected to the outer surface of the wall of the first end cap and the second end cap, respectively, wherein the outer ribs have a rib configuration different from the inner ribs, and the outer ribs are integrally molded with the inner ribs.
